(19) United States
(12) Patent Application Publication
(10) Pub. No.: US 2012/0143570 A1
(43) Pub. Date: Jun. 7, 2012

(54) METHOD AND SYSTEM FOR ONTOLOGY-ENABLED TRACEABILITY IN DESIGN AND MANAGEMENT APPLICATIONS

(75) Inventors: Mark AUSTIN, Columbia, MD (US); Cari E. WOJCIK, Newport, RI (US); PARASTOO DELGOSHAEI, Hyattsville, MD (US)

(73) Assignee: UNIVERSITY OF MARYLAND, COLLEGE PARK, MD (US)

(21) Appl. No.: 13/311,158

(22) Filed: Dec. 5, 2011

Related U.S. Application Data
(60) Provisional application No. 61/419,624, filed on Dec. 3, 2010.

(51) Int. Cl. G06F 17/50

(52) U.S. Cl. 703/1

(57) ABSTRACT

A system and method for ontology-enhanced traceability in design and management applications employ ontology nodes embedded in a processor executable traceability link (network) coupling processor executable requirement modules to processor executable engineering object modules to facilitate in all stages of engineering object development. The engineering object development occurs through multiple models of computation, control, and visualization platform networked together via ontology-enhanced traceability mechanism. Processor executable design rule checking module embedded in the design concept nodes creates a pathway for the development process validation and verification at early stages of the object lifecycle. Linking of ontologies/meta-models is performed for the purposes of supporting ontology-enabled traceability across multiple domains.

### REFERENCE TO RELATED APPLICATIONS

This Utility patent application is based on Provisional Patent Application Ser. No. 61/419,624 filed on 3 Dec. 2010.

### FIELD OF THE INVENTION

The present invention is directed to engineering objects development, and in particular, to a computer system supporting end-to-end development of engineering objects facilitated by unique ontology-enhanced traceability mechanisms which link requirements and engineering object solutions satisfying these requirements at all stages of engineering object lifecycle.

In overall concept, the present invention is directed to a system and method designed for satisfying requirements to the engineering object structure or behavior through the linking of the requirement(s) and resulting engineering object solution(s) via interaction relationships therebetween at the ontology (or meta-model) level supported by web-centric, graphically driven computational platforms dedicated to system-level planning, analysis, design, and verification of complex multi-disciplinary engineering objects.

The present invention further is directed to a system and method for engineering object development where an object is collaboratively developed in a multi-domain environment, i.e. with inclusion of requirements established in a number of disciplines/categories, and where semantic descriptions, i.e., the ontologies, of domains in multiple discipline/categories are interrelated and conglomerated to enable the ontology-based traceability across multiple disciplines/categories/domains.

In addition, the present invention is directed to a system and method for ontology-enabled traceability in design and management applications where the associated graphical (visual) platform promotes a shared comprehension of relationships between multiple disciplines/categories/domains, as well as shared understanding of change patterns and solution making on the issues of cause-and-effect and trade-off between functionality, performance and cost, within collaboratively developed engineering objects.

The present invention is further directed to engineering objects development process using ontology-enabled traceability, where the integral embedding of ontologies in traceability mechanisms is beneficial for a clear representation and understanding of a particular domain, and for indicating of “how and why” a requirement is met, as well as for establishing dependencies among different design viewpoints, e.g. system structure, system behavior, between different engineering disciplines and their concerns.

The present invention is also directed to engineering object development process capable of design rule checking at the earliest possible stages of the design lifecycle based on the understanding of ontologies of rules that separate acceptable functionality and performance from defective ones.

### BACKGROUND OF INVENTION

Real-world engineering systems are developed over multiple levels of abstraction (i.e., system, subsystem, component levels) using pre-defined strategies of development that are part top-down decomposition and part bottom-up assembly. Throughout the development process starting at a set of requirements to be satisfied towards the resulting object satisfying the requirements, a shared view of the project objectives is maintained among stakeholders and developers, i.e. engineers/designers. Simultaneously, a focus on specific tasks must be maintained. To ensure that the development process moves forward in a disciplined manner, pre-defined processes are needed for requirements development (elicitation, organization, visualization), system synthesis and design, integration and validation. The key elements of these capabilities are the ability to identify and manage the requirements during all phases of the system design and operational lifecycle.

The development pathway for one level of abstraction begins with the formation of an operations concept, requirements, fragments of behavior, and tentative models of system structure. Requirements need to be organized according to role they will play in the design (e.g., behavior, structure, test), and to be processed to insure consistency, completeness, and compatibility with the requirements system. Models of behavior dictate what the resulting system to be built will do. System performance can be evaluated with respect to the value of performance attributes. Models of structure specify how the system will accomplish its purpose. System architecture is to be evaluated with respect to selected objects, and the value of their attributes. System designs are created by assigning (or mapping) fragments of required object and subsystems in the system structure. Thus, the behavior-to-structure mapping defines (in a symbolic manner) the functional responsibility of each subsystem/component.

Finally, in the system evaluation, the functional and performance characteristics are evaluated against the test requirements. To satisfy all of the system requirements, multiple iterations of development (involving modifications to the operations concepts, system behavior, system structure) are usually required.

Documents containing an enormous number of requirements are commonplace. Therefore, requirements modeling and traceability management tools are an indispensable enabler of the system development process.

Traceability refers to the completeness of the information about every step in a process chain, and may be defined as the ability to chronologically interrelate uniquely identifiable entities in a way that is verifiable. Traceability mechanisms included within objects development processes allow for an understanding of how and why various parts of the system (object) development process are connected, thereby providing a development team with greater confidence in: (1) meeting objectives; (2) assessing the impact of change; (3) tracking process; and (4) conducting trade-off analysis of cost against other measures of effectiveness.

FIG. 1 represents the state-of-the-art traceability model, where a “Requirement” entity is directly connected to an “Engineering Object” entity. The “Requirement” entity contains a set of requirements which the resulting object is to meet. The “Engineering Object” entity is the design solution itself, either in the form of a model, or as a physical entity, or alternatively, it could be in the form of an element of system structure or system behavior.

In a comprehensive study of traceability models and meta-models, and their use in industry, users of traceability can be classified into two categories. Low-end users have problems that require less than about 1,000 requirements (viewed as a mandate from the project sponsors or for compliance with standards). They typically view traceability as a transformation of requirements documents to design. They also lack support for capturing rationale for requirements issues and how they are resolved.

High-end users of traceability tend to have problems that require, on average, about 10,000 requirements (viewed as a major opportunity for customer satisfaction and knowledge creation throughout the system lifecycle). They view traceability as an opportunity to increase the probability of producing a system that meets all customer requirements, is easier to maintain, and can be produced within cost and on schedule. High-end traceability employs much richer schemes of traceability (e.g., capture of discussion issues, decisions and rationale product-related and process-related dimensions) than their low-end counterparts. Traceability pathways of rationale enable accountability (e.g., what changes have been made; why and how they were made), particularly to stakeholders not directly involved in creation of the requirement.

Present-day requirements management tools such as SLATE (IBM Telelogic SLATE, 2009, http://www.cvaiglarman.com), CORE (http://www.vitechcorp.com/productline.html. 2009), and DOORS http://www.Telelogic.com/products/doorsers/doors/. 2009), provide support for top-down development where the focus is on requirements representation, traceability, and allocation of requirements to system abstractions. In most of today's requirements management tools, individual requirements are represented as textual descriptions with no underlying semantics.

In the state-of-the-art practice, system engineers prefer to organize groups of requirements (e.g., functional requirements, interface requirements) and abstractions for system development into tree-like hierarchies, in part, since this technique is comfortable and well known.

However, when requirements are organized into layers for a team development, graph structures are needed to comply define relationships, sometimes tracing across the same level. This happens because requirements are tightly interdependent with each other across the same level of abstraction. Since the underlying graphical formalism is weak, many questions that a user might want to ask about requirements and/or the system structure remain unanswered or omitted. The question of all complying and defining requirements that are related to a particular requirement cannot be answered.

Visualization mechanisms are used in the system development process in order to improve the effectiveness in which engineers/designers understand the problem under development.

Effective visualization techniques help end-users in understanding and study of the behavior and underlying cause-and-effect mechanisms within a phenomena. Unfortunately, state-of-the-art capability in requirements visualization falls short of these goals and, in fact, has not advanced much during the past two decades. Prior to 2006, visualization has been used primarily for three purposes: (1) to convey the structure and relations among evolving requirements and other system artifacts, (2) to support the organization of requirements and, downstream, the management of requirements during change, and (3) to model subsets of requirements (or properties of these requirements) for analytical/engineering purposes. However, in such state-of-the-art systems, the visual platform does not provide designers with capability to “actually see” the requirements in the context of their satisfaction and support for high-level decision-making activities.

For example, in SLATE, system-level designs are viewed as collections (e.g., networks and hierarchies) of functional units that form the major components of a system. Unfortunately, the underlying graphical support is weak in the sense that no provision exits for viewing a more detailed representation of the system after lower-level details have been worked out. For systems that require monitoring throughout their working lifetime, this is a major deficiency. Moreover, to date, no one has been able to figure out how to actually organize and visualize the subsystem viewpoints, and relationships between viewpoints, on a computer.

Together these weaknesses leave system and non-system engineers in a quandry, providing little visual assistance in understanding how requirements influence design objects, and in understanding how elements in one domain of engineering are affected by concerns in a different engineering domain. To overcome these limitations, a better representation of individual objects (requirements, abstraction blocks, and so forth) and an improved linkage of those entities to the overall architectural design are required.

### SUMMARY OF THE INVENTION

It is therefore an object of the present invention to provide a new approach to traceability between individual entities needed in an engineering object (system) development process in order to assist developers in comprehension of how these entities influence and are influenced by others.

It is another object of the present invention to provide a system and method for engineering object (system) development with an enhanced semantic representation of all involved entities and their interrelations via sufficient description of requirements attained through discipline-specific dependencies at an ontology (or meta-model) level.

It is a further object of the present invention to provide method and system where a “design concept” model is embedded in the traceability link between requirement model and engineering object model which may be beneficial in the following ways:

a. From an efficiency standpoint, the inclusion of ontologies in the design concept model within the traceability relationships helps object developers to deal with issues of system complexity by raising the level of abstruction within which systems may be represented and reasoned with. Furthermore, because ontologies represent concepts for a problem domain, the ontologies are inherently reusable across families of projects where the ontologies are applicable;

b. From a validation and verification standpoint, the key advantage of the proposed model is that software for “design rule checking” can be embedded in the design concepts model. Thus, rather than waiting until the design has been fully specified, this model has the potential for detecting rule violations at the earliest possible time in the system design lifecycle where errors are cheapest and easiest to fix. Moreover, in mechanisms created to dynamically load design concept modules into computer-based design environments, the rule checking procedure can be performed even if a designer is not an expert in a particular domain; and

c. From a modeling and visualization standpoint, this approach provides improved methods for visualization of requirements with respect to design objects. In an ideal setting, the latter should be visualized using a notation familiar to the engineer, e.g. a mechanical engineering drawing.

In addition, the object of the present invention is to provide a method and system for engineering objects development where designers/engineers are provided with an enhanced visualization tool to “see” how the requirements are satisfied and supported in decision making by mapping data/information about requirements onto visual artifacts, and to see how changes in any entity within the overall object development arrangement cause changes in other entities of interest.

In one aspect, the present invention constitutes a system for ontology-enhanced traceability in engineering objects development. The subject system is based on a computer system which receives, at the input end, requirements data, and is capable of generating a model of an engineering object solution satisfying the requirements data. The engineering object model can be output in a tangible format through the computer system.

The computer system has resources for attaining the object of the subject invention. The computer system, among its other structural and software elements, has memory, as well as a processor configured for engineering objects (systems) development through inclusion of processor executable requirement(s) modules containing the requirements data, and processor executable engineering object modules calculating the engineering object solution to meet the requirements data. The engineering object modules are operatively coupled to respective requirement modules through a traceability network, also referred to herein as a traceability mechanism.

Processor executable design concept modules are embedded in the traceability mechanism. The design concept modules are implemented as ontology based entities which contain information on a domain of the engineering objects stored in ontologies (to be defined in detail in further paragraphs), and thus contain a set of concepts justifying a tentative solution for the engineering object in view of the requirements.

The requirements may be produced from a multiplicity of disciplines/categories/domains standpoints. In order to attain the traceability across multiple domains concerning the engineering object in question, the ontologies/meta-models are linked and relationships/dependencies between domain specific ontologies are established.

The subject system further includes a processor executable visualization unit coupled to the requirement modules, design concept modules, and the engineering object modules to display their contents, and structural and behavioral correlation between the set of requirements, set of design concepts, and the engineering object solution in a predetermined format.

The subject system preferably comprises a processor executable design rule checking module operatively coupled to the design concept modules. This arrangement is beneficial in managing the object “quality” at different stages of development. The inclusion of the design rule checking is beneficial for detecting errors at the early stages of the object lifecycle, when it is least expensive to correct the errors.

Once a system has been designed and built and becomes operational, ontology-enabled traceability can switch purposes and support real-time performance assessment, which, in turn, provides data for decision making in system management. For this purpose, systems of sensors will be embedded in the as-built system, and operatively coupled to the engineering object module for generating data representative of the engineering object operation. The sensors' data are supplied to the design rule checking module, and when a status of the engineering object module changes, the design concept module generates a notification transmitted to the requirement module, thus providing highly efficient traceability between the entities involved. A visual indicator may be coupled to the requirement model module to display changes in the status of the set of requirements.

The engineering object module may produce the subject engineering object solution in form of a design model, or a physical entity, or an element of the engineering object behavior, depending on the stage of the object lifecycle and requirements for presentation format, such as in the form of engineering drawings, requirements diagrams, block-diagrams, activity diagrams, sequence diagrams, state chart diagrams, etc.

In actual implementation, where a large number of requirements pertaining to multiplicity of project domains, and multiple design concerns, a first plurality of requirement modules are interconnected in a processor executable requirements model workspace, a second plurality of design concept modules are interconnected in a processor executable design concept model workspace, and a third plurality of engineering object modules are interconnected in a processor executable engineering object model workspace. In this arrangement, the requirement model workspace, the design concept model workspace, and the engineering object model workspace are interrelated through an ontology-enhanced traceability linking network (complex processor executable traceability mechanism) containing multiplicity of bi-directional processor executable interaction mechanisms coupled between respective modules in the workspaces.

Each interaction mechanism may be composed of a processor executable dependency unit and a processor executable links unit, where the dependency unit may include a processor executable association relationship unit and processor executable organizational relationship unit, and wherein the links unit may include a processor executable compliance relationship unit and a processor executable satisfaction relationship unit.

The subject system is flexible enough to permit observation of the object development process of a specific state of the object lifecycle. For this purpose, the traceability network is partitioned under the processor control at a plurality of cross-cutting viewpoints levels, each corresponding to a specific stage of the engineering object development lifecycle. The traceability network also may be partitioned under the processor control at a plurality of basic viewpoints levels, each corresponding to a predetermined aspect of the engineering object development. Thus, the subject system permits traceability at different levels. Processor executable visualization is provided at the levels in question, as well as for developers and stakeholders interests.

The requirements may be formulated by engineers of different disciplines. To accommodate this aspect, the requirement model workspace may cover a plurality of requirements domains interrelated through the ontology-enhanced traceability network to formulate interrelationship between elements in multiple domains/categories/disciplines, and to make the process more efficient.

In the subject system, each of the requirement model workspace, design concept model workspace, and engineering object model workspace includes a respective workspace controller. The workspaces communicate through their controllers. The workspace controllers in the system are coupled in a network of source controllers and a plurality of receiving (listeners) controllers. The source controller notifies the receiving controllers of a status change in a respective workspace, and sends out a list of workspace controllers being notified to avoid unneeded over-transmission of data in the system.

The requirement model module, engineering object model module, and the design concept model module may be implemented in a variety of visual formalisms, the uniform modeling language (UML), the systems engineering markup language (SysML), or with Web Ontology Language (OWL).

The processor executable requirement modules, design concept modules, and engineering object modules are adapted to manage connectivity relationships with other processor executable modules, and to propagate changes in the status of modules when detected.

The subject system further includes a synchronization software module which is responsible for synchronizing “visuality” of corresponding entities of interest through the entire system. For example, if a user interacts with an engineering object module (or workspace) through the corresponding display to highlight an element of interest, the synchronization module initializes the process of highlighting a corresponding element (or an element influenced by the highlighted element) on the display of another module (workspace). The synchronization procedure facilitates the visualization of interrelated elements through the entire system.

In another aspect, the present invention constitutes a method for ontology-enabled traceability in an engineering object development process, which comprises the steps of:

configuring a computer system to support a system architecture composed of a first plurality of processor executable requirement modules and a second plurality of processor executable engineering design modules interconnected via a processor executable traceability linking network,

embedding into the traceability linking network a third plurality of design concept modules, wherein each design concept module is operatively coupled between a respective requirement module and a respective engineering object module.

It is possible to interrelate, through the traceability linking network, a plurality of requirement domains in the requirement model workspace.

The process continues by partitioning, through a computational process in the computer system, the system architecture into a processor executable requirement model workspace composed of the first plurality of requirement model modules, into a design concept model workspace composed of the third plurality of design concept modules, and into a processor executable engineering object model workspace composed of the second plurality of engineering object modules.

The contents of each of the requirement model workspace, design concept model workspace, and engineering object model workspace are visualized, under the processor control, in a respective predetermined format on a display unit (or other visualizing means). By interacting with an item of interest contained in at least one of the requirement model workspace, design concept model workspace, and engineering object model workspace, a processor executable synchronization procedure is initialized through the action of the computer system, which operates to “highlight” on the display a corresponding another item found in the same or in another workspace. That item is correlated to the item of interest through the ontology-enhanced traceability linking network. Synchronization procedures will also maintain consistency in the requirements, ontology, and engineering model states.

These and other objects and advantages of the present invention will become apparent from a further detailed description of the preferred embodiments taken in conjunction with the accompanying Patent Drawings presented in the current patent application.

### BRIEF DESCRIPTION OF THE DRAWINGS

FIG. 1 is the block-diagram of a prior art traceability model;

FIG. 2 is a simplified block-diagram illustrating basic principles underlying the operation of the subject system;

FIG. 3 is a block-diagram of ontology-enabled traceability system and method of the present invention extended to multiple-viewpoint design;

FIG. 4 is a block-diagram representative of an interaction mechanism associated with a system decomposed and subsequently refined into collection of objects to simplify the system development process of the present invention;

FIG. 5 is a block-diagram representative of class hierarchy of dependence relationships among requirements/ontologies/engineering objects;

FIG. 6 is a block-diagram representative of the system of the present invention modified for ontology-enabled traceability support for performance assessment and system management;

FIG. 7 is a block-diagram representative of the subject system architecture viewed as a network of loosely coupled entities connected via traceability mechanisms and interfaces for communication of events and data required for tracking dependencies and evaluating design rules;

FIG. 8 is a block-diagram representative of a multiple-viewpoint design of the system of the present invention arranged in the requirements, ontology, and engineering model/implementation workspaces;

FIG. 9 is a block-diagram of the software architecture implemented as a two-level graph of model-view-controllers for ontology-enabled traceability of the present invention;

FIG. 10 is a flowdown diagram of requirements in the V-Model of System Development;

FIG. 11 is a flowchart diagram of the step-by-step procedure for development of requirements, selection of ontologies, and development and assessment of the object (system) solution alternatives;

FIG. 12 is a block-diagram representation of the Model-View-Controller interactions;

FIG. 13 is a block-diagram representation of the Model-View-Controller interaction of the present invention supporting the objects definition mechanism in the subject system, including attributes of the object structure as well as the object behavior;

FIG. 14 is a block-diagram representation of the workspace structure and behavior definition in the system of the present invention;

FIG. 15 is a pictorial view of a graphical display of requirements and ontology classes associated with attributes of the College Park Metro Station in the application of the subject system and method for prototyping the Washington D.C. Metro System;

FIG. 16 is a schematic illustration of another application of the subject system and method for renovation of a house wall with a provision for design rule checking;

FIG. 17 is a schematic representation of a system for multi-conceptual interpretations, i.e., for the capture of dependencies between architectural and structural engineering design concerns at the model level in the house wall where dependency pathways are captured from requirements to wall primitives to attributes of the wall system;

FIG. 18 is a representation of a graphical display illustrating the ontology-enabled traceability, i.e. ontologies are used for architectural engineering and structural engineering concerns linkage;

FIG. 19 is a block-diagram combined with visual (display) representation of ontology-enabled traceability mechanism in the application for prototyping for a lamp operation;

FIG. 20 is a block-diagram combined with visual representation of the ontology-enabled traceability mechanism in the application for prototyping operation of the Washington D.C. Metro System; and

FIG. 21 is a pictorial diagram of a graphical display requirement-ontology-engineering traceability in the application for prototyping of the Washington D.C. Metro System model, as presented in FIG. 15, with the addition of timetable-driven train behavior.

### DESCRIPTION OF THE PREFERRED EMBODIMENT OF THE INVENTION

The present system and method are based on a new approach to requirements traceability during the development of an engineering object which may be useful in design and management applications in a variety of areas.

Now that systems engineering models and documents containing thousands and, sometimes, tens-of-thousands of requirements are commonplace, requirements modeling and traceability management tools are an indispensible enabler of the system development process.

Traceability mechanisms allow for an understanding of how and why various parts of the system development process are connected, thereby providing development teams a greater confidence in meeting objectives, assessing the impact of any change in design, behavior, a.k.a. status, tracking progress, conducting trade-off analysis of cost against other measures of effectiveness, and formalizing procedures for system validation and verification. Traceability mechanism works together with visual formulations, since the latter improves the effectiveness with which engineers understand a problem under development.

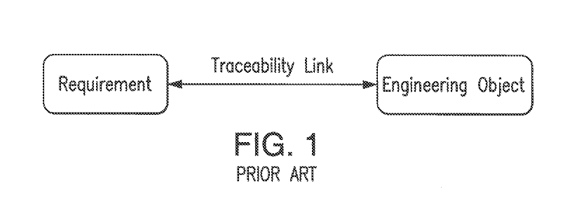

Unlike prior art traceability mechanisms where requirements are connected directly to design objects, as shown in FIG. 1, the present system and method introduces an additional node in the traceability mechanism linking the requirements and engineering objects which introduces a set of design concepts (also referred to as a family of concepts). The design concepts are applied to the engineering object development process to satisfy the requirements. When the family of design concepts is available, then the implementation of these concepts leads to the design itself. In the subject system, the additional node (also referred to herein as a module) embedded in the traceability mechanism between the requirements and the engineering object (in any form including engineering object model, physical entity, system behavior, etc.) results in an ontology-enabled traceability which enhances the process of the engineering object development, makes it flexible and versatile, as well as more effective than prior art traceability mechanisms.

As will be detailed in further paragraphs, the subject ontology-enabled traceability implemented through the inclusion of the design concept nodes (or modules) in the traceability links between the requirements and engineering objects provides for multiple benefits, such as for example:

(1) procedures for design rule checking may be embedded into the design concept nodes, thereby creating a pathway for system validation and verification processes that may be executed early in the engineering object (system)'s lifecycle where errors can easily be identified and corrected;

(2) from an efficiency standpoint, the use of ontologies within traceability relationships helps engineers and designers deal with issues of system complexity by raising the level of abstraction within which systems may be represented and reasoned with. Furthermore, since ontologies represent concepts for a problem domain, the ontologies are inherently reusable; and

(3) from a modeling and visualization standpoint, the subject approach “opens the door” to improved methods for the visualization of requirements with respect to engineering objects. Advantageously, the visualization may be chosen in a format familiar to a designer/engineer to simplify interfacing with the subject system.

An ontology is a set of knowledge terms, including vocabulary, semantic interconnections, and rules of inference and logic for some particular topic (or domain). To provide for a formal conceptualization within a particular domain, and for people and computers to share, exchange, and translate information within a domain, an ontology needs to accomplish the following objectives:

1. provide a semantic representation of each entity and its relationships to other entities;

2. provide constraints and rules that permit reasoning within the ontology; and

3. describe behavior associated with the stated or inferred facts.

Items 1 and 2 in the above presented list cover the concepts and relations that are essential to describing a problem domain. Items 2 and 3 cover axioms that are often associated with an ontology. Axioms may be encoded in some form of first-order logic. For the purpose of the description of the present system and method, it is assumed that the ontology-enabled design and development occurs in parallel with advances in the semantic web.

There is a distinction between ontologies that are taxonomies and those that model domains in depth, applying restrictions on domain semantics. (A. Gomez-Perez, et al., Ontological Engineering, Springer, 2004). Lightweight ontologies include concepts, concept taxonomies, relationships between concepts, and properties of the concepts. Heavyweight ontologies add axioms to lightweight ontologies. The axioms serve the purpose of adding clarity to the meaning of terms in the ontology. They can be modeled with first-order logic. Top-level ontologies describe general concepts (e.g., space, connectivity, etc.). Domain ontologies describe a vocabulary related to a particular domain (e.g., building architecture, plumbing, etc.). Task ontologies describe a task or activity. Application ontologies describe concepts that depend on both a specific domain and task. These ontologies might represent users needs with respect to a specific application.

The term “semantic” refers to the meaning of relations between signifiers, such as words, phrases, signs, and symbols, and their meaning, i.e. their denotata. Computational semantics is focused on the processing of linguistic meaning by describing concrete algorithms and architectures. In computer science, the term “semantics” refers to the meaning of languages, and thus semantics provides the rules for interpreting the syntax (form of the programming languages).

The Semantic Web (J. Hendler, Agents and the Semantic Web, IEEE Intelligent Systems, pages 30-37, March/April 2001) aims to give information a well-defined meaning, thereby creating a pathway for machine-to-machine communication and automated services based on descriptions of semantics (V. Geromenko et al., Visualizing the Semantic Web: XML-based Internet and Information Visualization, Springer, 2003). Realization of this goal requires mechanisms (i.e., markup languages) that enable the introduction, coordination, and sharing of the formal semantics of data, as well as an ability to reason and draw conclusions (i.e., inference) from semantic data obtained by following hyperlinks to definitions of problem domain(s) (i.e., ontologies). The subject system and method are contemplated to make use of Semantic Web technologies for storage, exchange, management, and visualization of requirements.

In the technical infrastructure that supports the Semantic Web vision, each new layer builds on the layers of technology below it. The bottom layer is constructed of Universal Resource Identifiers (URI) and Unicode. URIs are a generalized mechanism for specifying a unique address for an item. They provide the basis for linking information on the Internet. Unicode is the 16-bit extension of ASCII text—it assigns a unique platform-independent and language-independent number to every character, thereby allowing any language to be represented on any platform.

The eXtensible Markup Language (XML) provides the fundamental layer for representation and management of data on the Web. The XML grew out of demands to make the hypertext markup language (HTML) more flexible. The technology itself has two aspects. On one hand, it is an open standard which describes how to declare and use simple tree-based data structures within a plain text file (human readable format).

On another hand, the XML is a meta-language (or set of rules) for defining domain-or-industry-specific markup languages. As an example, a mathematical language specification (MathML), captures the structure and content of mathematical notation (2002, MathML, Referenced on Apr. 6, 2002 in http://www.w3.org/Math). Another example is the scalable vector graphics (SVG) markup language, which defines two-dimensional vector graphics in a compact text format (Scalar Vector Graphics (SVG), referenced on Apr. 5, 2002 in http://www.w3.org/Graphics/SVG/Overview.html).

XML is being used in the implementation of AP233, a standard for exchange of systems engineering data among tools (D. Muller, “Requirements Engineering Knowledge Management based on STEP AP233”, 2003). A key benefit in representing data in XML is that data can be filtered, sorted and re-purposed for different devices using the Extensible Stylesheet Language Transformation (XSLT) (D. Tidwell, XSLT, O'Reilly and Associates, Sebastopol, Calif., 2001; and “XML Stylesheet Transformation Language (XSLT)” in http://www.w3.org/Style/XSL, 2002). Stylesheets contain collections of rules and instructions that inform the XSLT processor how to produce the details of output. For example, a single XML file can be presented to the web and paper through two different style sheets.

While XML provides support for the portable encoding of data, it is limited to information that can be organized within hierarchical relationships. A common engineering task, which is the synthesis information from multiple data sources, can be a problematic situation for XML as a synthesized object may or may not fit into a hierarchical (tree) model. A graph, however, does fit into a hierarchical model, and thus the Resource Description Framework (RDF) is used for such purpose.

RDF is a graph-based assertional data model for describing the relationships between objects and classes in a general but simple manner. The primary uses of RDF are to encode metadata-information, such as the title, author, and subject about Web resources, and to designate at least one understanding of a schema that is sharable and understandable. The graph-based nature of RDF means that it can resolve circular references, an inherent problem of the hierarchical structure of XML.

An assertion is the smallest expression of useful information. RDF captures assertions made in simple sentences by connecting a subject to an object and a verb. In practical terms, English statements are transformed into RDF triples consisting of a subject (this is the entity the statement is about), a predicate (this is the named attribute, or property, of the subject), and an object (the value of the named attribute). Subjects are denoted by a URI.

Each property has a specific meaning and may define its permitted values, the types of resources it can describe, and its relationship with other properties.

Objects are denoted by a “string” or URI. The latter can be in form of web resources such as requirements documents, other Web pages or, more generally, any resource that can be referenced using a URI (e.g., an application program or service program). Class relationships and statements about a problem domain are expressed in DAML+OIL (DARPA Agent Markup Language) and more recently, the Web Ontology Language (OWL) (Web Ontology Language (OWL) in http://www/w3.org/TR/owl-ref/, 2003).

The ontology, logic, proof and trust layers introduce vocabularies, logical reasoning, establishment of consistency and correctness, and evidence of trustworthiness into the Semantic Web framework.

In a description of the system and method of the present invention, the following concepts are used:

1. An architecture is a fundamental organization of a system embodied in its components, their relationships to each other, and to the environment, and the principles guiding its design and evolution.

2. A system stakeholder is an individual, team, or organization (or classes thereof) with interests in, or concerns relative to, a system.

3. Concerns are those interests which pertain to the systems development, its operation, or any other aspects that are of critical importance to one or more stakeholders. Typical concerns include considerations such as system functionality, performance, reliability, security, distribution, ease of evolvability, schedule of development, maintenance and cost.

4. A view is a representation of an entire system from the perspective of a related set of concerns.

5. A viewpoint is a specification of the conventions for constructing and using a view. There is a one-to-one correspondence between a view and a viewpoint. As such, the viewpoint determines the languages (including notations, model, or product types) that will be used to assemble the view, as well as any associated modeling/analysis techniques.

These languages and techniques are used to yield results relevant to the concerns addressed by the viewpoint. For example, the class and statechart diagram types in UML define the semantics for representing diagrams that aid engineers in understanding system structure and behavior, respectively. A second example of this process is the multi-resolution capabilities of Google Maps. When multiple visual representations of the same model are needed (e.g., different projection views of a house), software implementations should follow the model-view-controller (MVC) design pattern.

6. Viewpoints may be partitioned into basic viewpoints and cross-cutting viewpoints.

Basic viewpoints are associated with views that can be represented by a singular type of model or entity (e.g., a requirements model, a functional model, a specific module or subsystem). Cross-cutting viewpoints cut across basic viewpoints, for example, multiple stages of development (e.g., requirements, implementation) and/or multiple subsystems (e.g., to evaluate system reliability and/or security).

7. Architectural models are developed using the procedures and methods established by the associated architectural viewpoint.

In pursuit toward enhanced functionality and higher performance, the entities in the subject system, i.e., processor executable requirements, design concepts, and engineering object modules, are designed to be multi-functional, which means that they participate in the satisfaction of multiple stakeholder needs and their associated viewpoints. Hence, there is a strong need to represent not only multiple perspectives in design, but relationships between these perspectives. Overlaps in system functionality must be identified. Complementary participants must be made to interact and cooperate with contradictions being resolved.

Each stakeholder typically has interests in, or concerns relative to, that system. The uppermost layer of this arrangement has an architecture which, in turn, is described by one architecture description. The architectural description is organized by one or more views and one or more architectural models. Then, in turn, an architectural description selects one or more viewpoints for use. Each view addresses one or more of the concerns of the system's stakeholders. Thus, stakeholders may have one or more concerns, which are covered by viewpoints, views and models. Alternatively, an architectural model may participate in more than one view, each conforming to a viewpoint developed to answer questions about specific stakeholder concerns.

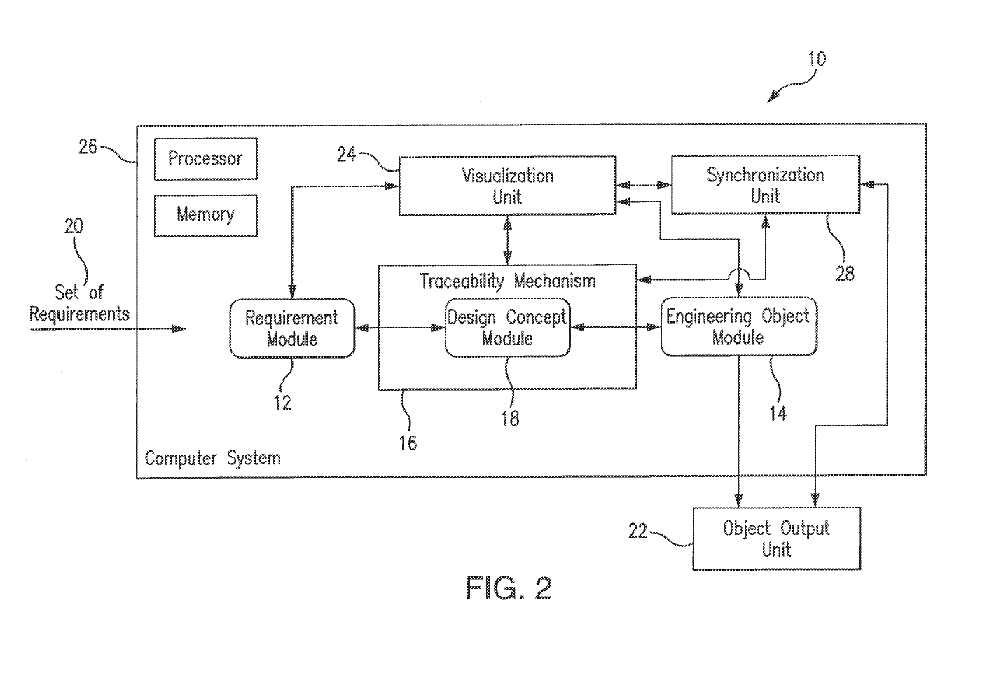

Referring to FIG. 2 which is a block-diagram of the simplified system 10 of the present invention, representing a single design concept embedded into the system of a single requirement for development of a single design object. The system 10, for ontology-enabled traceability in design and management applications, includes a requirement module 12 and an engineering object module 14 bi-directionally coupled each to the other through a traceability mechanism (also referred to herein as a traceability link) 16. A design concept module 18 is embedded into the traceability mechanism 16. The design concept in the module 18 is a fragment of knowledge about a domain that will be potentially useful in helping to satisfy the requirement. The design concepts are stored in the design concept module 18 in ontologies described in previous paragraphs.

A set of requirements 20, which in the example presented in FIG. 2 is represented by a single requirement, is formulated by stakeholders, engineers, etc. which are looking for satisfaction of the requirement at the resulting engineering object. A requirement is some condition that the engineering object must satisfy. The set of requirements 20 is stored in the requirement module 12.

In the engineering object module 14, an engineering object of interest is formulated which must satisfy the requirements contained in the requirement module 12. At the design stage of the object lifecycle, the engineering object is presented as an object model.

The engineering object module 14 may output structural and behavioral specifics of the engineering object in question through an output unit 22 in any preferable visual format including drawings, specifications, textual information, etc.

For example, the engineering object in the form of the physical (tangible) entity may be a station in the Washington D.C. Metro System presented in following paragraphs, or it could be an element of the system behavior (e.g. for example, trains beginning their operation at 5 A.M.; or the speed of the trains does not exceed 35 mph) as will be detailed in the following paragraphs. The object output unit 22 maybe implemented as a computer display, printer, speaker, disc drives, floppy discs, headphones, plotter, etc.

A visualization unit 24 is operatively coupled to the requirement module 12, engineering object module 14, design concept module 18, as well as object output unit 22 to serve the purpose of visualization of the information contained in any of those modules, as will be presented in detail in following paragraphs.

The entire system is based on and controlled by a computer system 26 which is configured for object development and management tasks, and which applies modeling design concepts represented through semantic web languages, and provides all necessary resources for controlling the operation of the subject system.

The computer system is provided with a processor configured to correlate visualization of all related elements through the system, when either one of these elements is “highlighted” by a user at one of the modules, or changes in element state occur due to its behavior. For this purpose, the computer system 26 is formatted with a synchronization module 28 which is operatively coupled, through the traceability mechanism 16, and/or directly, to all entities of the system 10, including the visualization unit 24, modules 12, 14, and 18, as well as the object output unit 22 for correlating the operation of all entities, as will be presented in further paragraphs.

Through the use of the subject system 10 designed with ontology-enhanced traceability, a designer/engineer is provided with a powerful tool for tracing the concepts which went into the engineering object implementation, as well as to trace which requirements led to the use of those concepts.

A traceability pathway in the direction from the requirements module 12 to the design concept module 18 and engineering object module 14 are also provided in the system 10. An engineer/designer thus is provided with the capability to look at the “design concept” and see what role it played in: (1) the satisfaction of requirements, and (2) the creation of engineering objects, i.e. the design. Processor executable visualization unit 24, as well as processor executable synchronization module 28, provide for these features in the system.

FIG. 2 is simplistic in the sense that it implies a single requirement which will be satisfied by the application of a single design concept represented as a concept in the module 18, which in turn will trace to a single engineering object in the engineering object module 14.

A more realistic design scenario involves multiple stakeholders, each with a number respective concerns, multiple view-points, numerous models, and scopes of influence on a project. Real-world systems are much more likely to correspond to assemblies of design entities, organized into hierarchies along disciplinary lines, with each design entity representing a meaningful concept to one or more system stakeholders (M. A. Rosenman et al., Modeling Multiple Views of Design Objects in a Collaborative CAD Environment, Computer-aided Design, 28 (3):193-205, 1996). To accommodate these relationships in a disciplined way, there needs to be a formal framework for: (1) connecting stakeholder concerns to engineering entities, (2) capturing the interactions and restrictions among the various viewpoints, and (3) systematically abstracting away details of a problem specification that are unrelated to a particular decision.

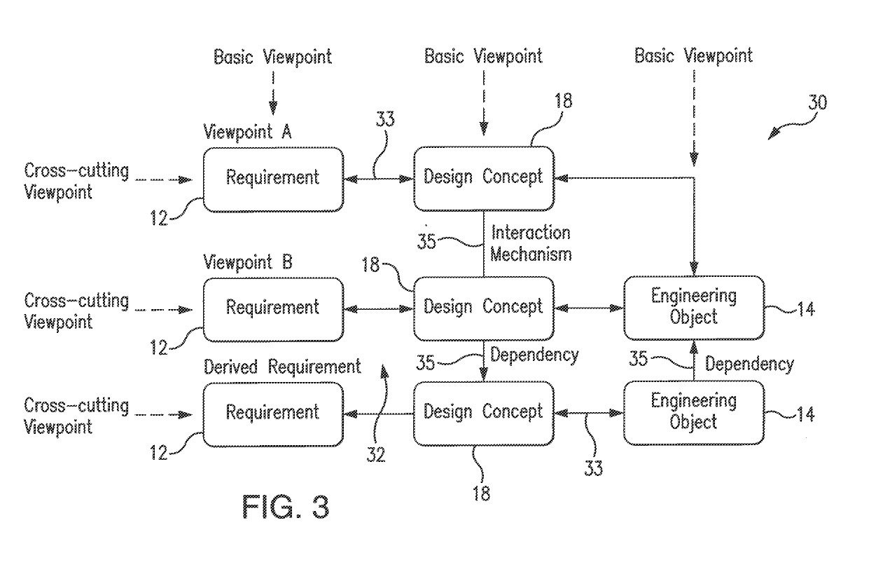

A real-world subject system is shown in FIG. 3, which represents the extension of the system 10 shown in FIG. 2 into a multi-viewpoint system 30 which includes a plurality of processor executable requirement modules 12, a plurality of processor executable design concept modules 18, and a plurality of processor executable engineering object modules 14 interconnected through a complex traceability network 32.

In FIG. 3, the horizontal arrows 33 (traceability links between modules) 33 serve the same purpose as in FIG. 2 but now constitute a simplified visual representation for one portion of a chain of many-to-many relationships. Dependences and interactions among domains are represented by the vertical lines and arrows 35, e.g. linking of ontologies (design concept and engineering object entities).

The multiple-viewpoint system 30 shown in FIG. 3 thus represents a chain of many-to-many relationships between the entities (requirement modules, engineering object modules, and design concept modules). In the system 30, a single requirement may be satisfied through the implementation of one or more design concepts, which, in turn may be implemented as a set of engineering entities. Similarly, a single design entity (engineering object module) may help to satisfy multiple design concepts, i.e. it could be multi-functional, which in turn may trace back to numerous requirements.

In the multiple viewpoint design presented in FIG. 3, architecture descriptions are inherently multiview, with no single view adequately capturing all of the stakeholder concerns. The potential complexity of this problem is due to existence of the chain of many-to-many relationships (traceability network) 32 between stakeholders and their concerns, and then concerns and their study through the implementation of multiple viewpoints. An explicit description of how the concerns associated with the various viewpoints will actually interact is necessary. In some cases the relationship between concerns are purely symbolic (e.g., entities A and B are the same). But dependencies might also be physical, requiring an understanding of notions such as connectivity and constraint, flows of data/energy, and scheduling and coordination. Additionally, the issue of how the models of an object/system will relate to the actual physical object/system is to be resolved. To overcome these problems, these issues may be affected by looking at functional and viewpoint interaction at two levels of abstraction: (1) the model level, and (2) the meta-model level.

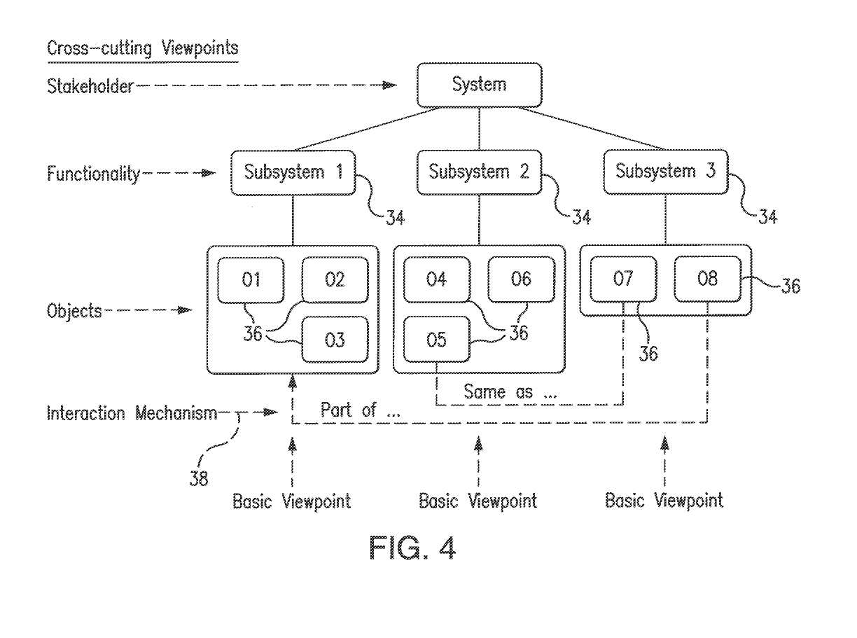

The nature of dependency and interaction relationships constitutes a complex issue. FIG. 4 shows, for example, a system (object) organized into (disciplinary-specific) hierarchies and several examples of dependency relationship between viewpoints: (1) “same as” (i.e., the element has all of the properties of the “named” element); (2) “element of” (i.e., the element is a component of the “named” element), not shown in FIG. 4; and (3) “part of” (i.e., the element forms part of the “named” element), and constrained by (i.e., a property of an element is constrained by the property of another). FIG. 4 implies that design entities will be viewed in a consistent manner.

However, a much more common situation is that each discipline will model and view design objects relevant to their set of concerns and may not even use the same terms to describe the same design object. For example, building architects may refer to horizontal planes as floors. Structural engineers may refer to the same object as a slab. And, in fact, because these disciplines often work at different stages of project development, neither single unified objects models, nor single unified system models can be guaranteed.

### Modeling Interactions in Dependencies Among Viewpoints.

In moving from FIG. 2 to FIG. 3, the main complication is the expansion of a simple requirement-ontology-object chain of FIG. 2 into a graph presented in FIG. 3.

Established approaches to engineering design simplifies the process by breaking the overall problem into networks of sub-problems, each of which are assumed to be easier to deal with. This process of simplification is called top-down decomposition. FIG. 4 shows, for example, a system being decomposed into subsystems 34: subsystem 1, subsystem 2, and subsystem 3; and subsequently refined into collections of objects 36. If the system presented in FIG. 4 was a building, then subsystem 1, 2, and 3 might be architectural, heating and ventilation, and structural systems, for example. The architectural objects 36 might be the rooms/spaces, walls, floors, ceilings, doors, windows, passageways, etc.

In an ideal world, each of these subsystems 34 would be designed and implemented in a completely independent fashion. In real world applications, however, decisions made in one discipline will place constraints on other disciplines (e.g., an architectural decision on where to place the walls in a house limit the options that structural engineer has in positioning of beams and columns, and places where HVAC systems can be installed). A mechanical engineer might request that the HVAC system has to be placed in a specific space, i.e., the HVAC is “part of” this specific space. Further complications may occur because each discipline will use models and visual formalisms tailored to their specific needs. This leads to situations where objects in separate domains are actually the same physical object. Thus, the need exists to express “same as” relationships.

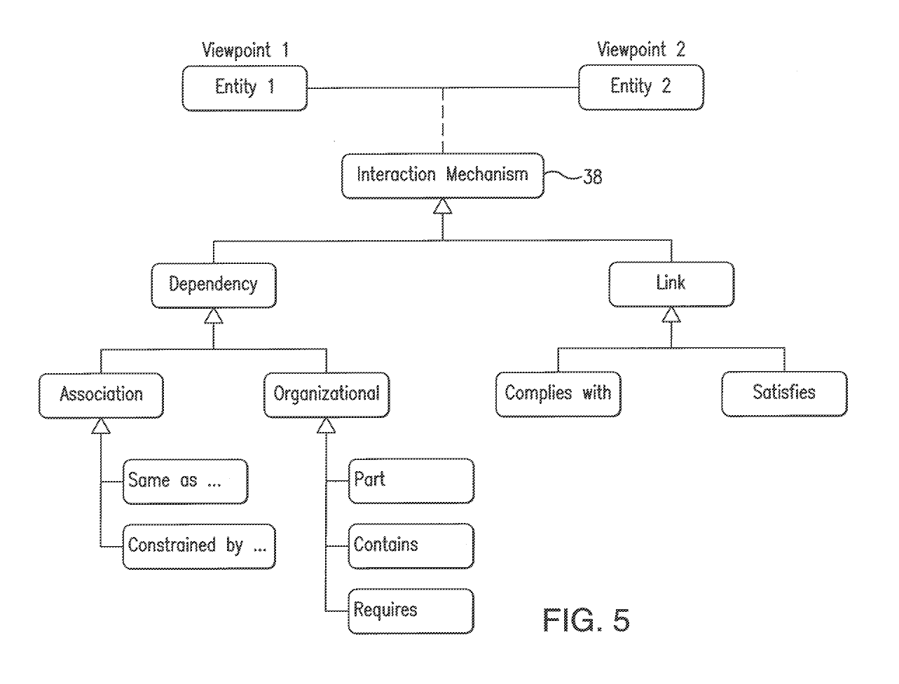

To handle the range of interaction and dependency types that occur in the requirements, ontologies, and engineering objects/implementations, a general model for interaction mechanisms 38 has been designed. In the present system and method, the class hierarchy of dependency relationships among design entities is presented in FIG. 5, where interaction mechanisms 38 may be partitioned, for example, into dependencies and links. Dependencies are a generalization of association (same as; constrained by) and organizational (part of/contain/required) relationships. Links can be partitioned into “complies with” and “such as” relationships.

Each of the main entities in ontology-enabled traceability (i.e., the requirements, the ontologies, the engineering object models) are implemented using models and visual formalisms that favor their needs. The uniform modeling language (UML) may be used to visually display graphs of ontology design concepts, and the structure and behavioral aspects of software programs in the subject system. Also, the SysML, the systems engineering markup language may be used for the same purpose. SysML, in particular, provides diagram types for the representation of requirements (i.e., requirements diagram), systems structures (e.g., block-diagram), and various aspects of system behavior (e.g., activity diagram, sequence diagram, statechart diagram).

The ontology-enabled traceability mechanisms of the present invention (1) works together with standard visual formalisms for representing requirements, ontologies and engineering models, and (2) allow for a requirement to trace into an element of a diagram type. As an example of point 1, UML class diagrams are used to visually display ontologies for two viewpoints of system structure as will be presented in further paragraphs. Equivalent functionality could occur with the SysML and the Web Ontology Language (OWL).

Point 2 is illustrated in Applications (behavior modeling for a simple lamp, and behavior modeling for trains on the Washington D.C. Metro System) where requirements on lamp and train behavior are traced to the guard condition element of statechart diagrams.

In the present system, the ontology-enabled traceability mechanisms are contemplated with a major intent to improving the way engineers design and create objects. However it is evident that once a system has been designed and built, ontology-enabled traceability mechanisms may switch purposes and support real-time performance assessment, which in turn, provides data for decision making in systems management.

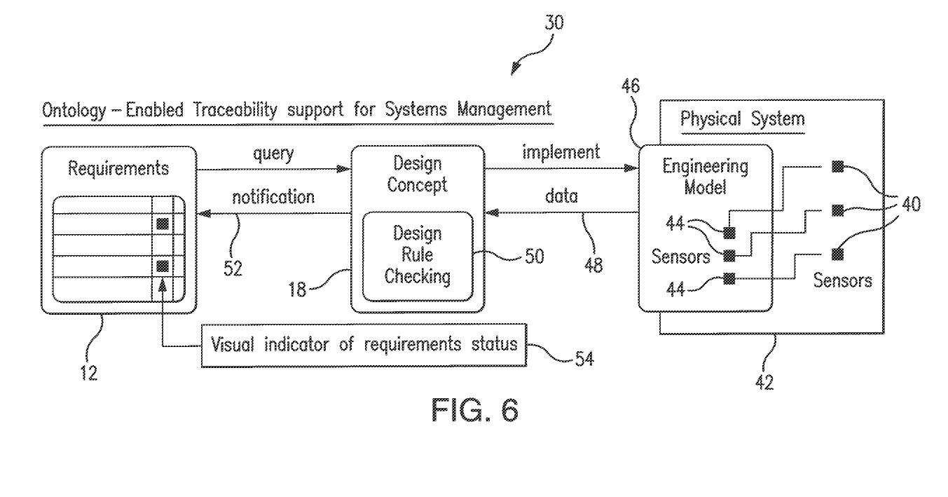

FIG. 6 shows the role that sensing and design rule checking will play in ontology-enabled traceability support for systems management. In engineering object development, which is a left-to-right flow of activities in FIG. 6, requirements are satisfied through the selection of design concepts, which, in turn, are implemented as detailed (engineering) model and further downstream, the as-built system itself.

For systems management, which corresponds to a right-to-left flow of activities in FIG. 6, a system of sensors 40 embedded in the real-world physical system 42 to collect and transmit streams of data to models of sensors 44 in the engineering model 46. Then, the data 48 are forwarded to procedures for design rule checking (design compliance) module 50 operatively coupled to (or embedded in) the ontologies module 18. When a change in rule checking status occur (e.g., as a result of an element failure in the physical system 42). A notification 52 may be sent to the requirement node (module) 12. Visual indicators 54 may be used to visualize changes in requirements status.

In the system presented in FIG. 6, the ontologies (design concept) node 18 is required to do more than simply represent concepts in a knowledge domain and provide support for logical reasoning. It also manages connectivity relationships to/from the requirements and design objects/systems and propagates changes in system status when they are detected. The requirements node and engineering object/model nodes provide similar functionality in terms of management of connections and communication of queries/data.

The following observations have been used for the purpose of subject system implementation:

1. From a design perspective, the requirements, ontology, and engineering models, shown in FIGS. 2 and 3, provide distinct views of a design. Requirements models are statements of “what is required”. Engineering models are statements of “how” the required functionality and performance might be achieved. Ontologies are statements of “concepts” justifying a tentative design solution. Generally speaking, requirements and engineering models are defined in an iterative manner, with a focus on covering the breadth of a problem before focusing on developing the design details.

2. In engineering teams, the participants play a variety of roles. Project stakeholders wish to know how their interest and concerns have been taken into account in development of the requirements, use of concepts in developing solutions, and in the engineering model. These are cross-cutting viewpoints, shown in FIG. 3, because they are interested in the results of various stages of the system development. Other engineers are interested in only one particular aspect of the project development. For example, a requirements engineer may only be concerned with the gathering, representation, and organization of requirements across all viewpoints. This is referred to as a basic viewpoint, shown in FIG. 3. Discipline-specific engineers may only be interested in creating engineering models relevant to their discipline. This is presented as a second basic viewpoint in FIG. 3.

3. In order for the system implementation to be useful, it will need to be scalable to hundreds and possibly thousands of requirements, numerous ontologies, and a number of engineering models. The subject system implementation overcomes these challenges through: (1) decomposition of the overall system architecture into requirements, ontology and engineering model workspaces, (2) strategic use of software design patterns to provide all of the project stakeholders with views of project results relevant to their interest, and (3) system implementations distributed across a computer network.

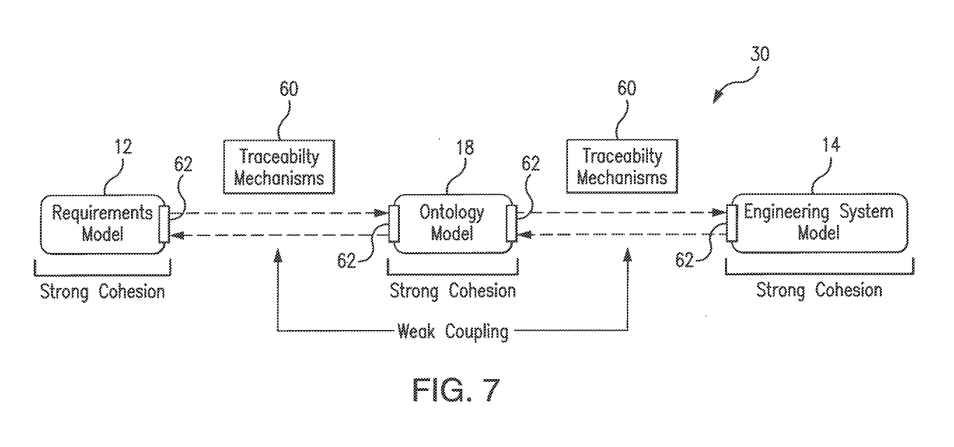

As shown in FIG. 7, it is expected that software implementations operate as a network of loosely coupled systems, connected only by traceability mechanisms 60 and interfaces 62 for communication of events and required data for tracking of dependencies and evaluation of design rules.

The connectivity in the system is understood as: (1) linking of requirements to objects in the ontology model (e.g., UML classes), and (2) linking of items in the ontology model to objects in the engineering model. However, because traceability relationships need to be bi-directional, connectivity also means: (3) linking of objects in the engineering model back to concepts in the ontology model, and (4) linking of concepts in the ontology back to the requirements.

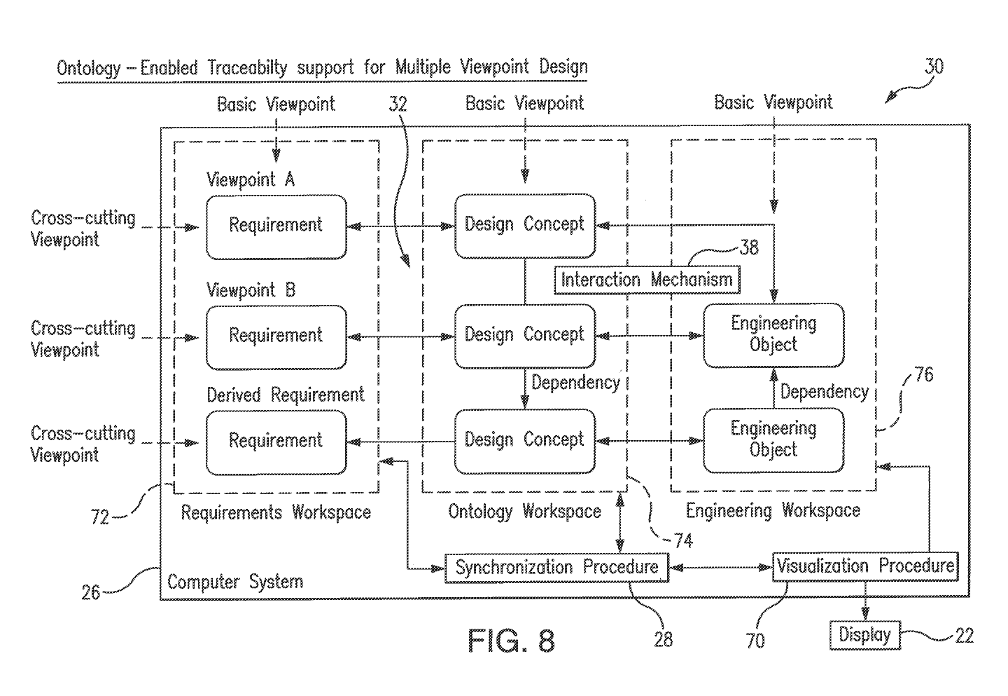

Referring to FIGS. 3, and 7-8, where FIG. 8 is derived from FIG. 3 by molding it into the system architecture framework of FIG. 7, since each of the modules 12, 14, 18 in FIG. 7 is expected to have strong cohesion and only be weakly coupled to the other modules, software support is implemented for each of the basic viewpoints (e.g., requirements engineering; ontology engineering) as a separate workspace.

It is expected that real-world implementations of the subject ontology-enabled traceability will need to handle multiplicity (hundreds, and possibly thousands) of requirements, possibly dozens of ontologies, and engineering models containing thousands of components and connections among components. A preferred way of handling and presenting information associated with each of these design concerns may be, for example, through distribution across multiple computers, with machines dedicated to supporting a particular phase of the systems engineering development.

Thus, the system 30 supporting the multi-viewpoint design, as shown in FIG. 8, includes a requirements model workspace 72, an ontology model workspace 74, and engineering model workspace 76, each of which is composed of a plurality of modules 12, 18 and 14, respectively. Within each workspace model, the entities 12, 14 and 18 have unique identities. The computer system 26 provides software tools including a visualization software 70 written to visualize the contents of modules 12, 14 and 18 in a variety of ways (e.g., table view, tree views, graph views, 2D and 3D plot views; spreadsheet views) to be displayed at some form at the display 22.

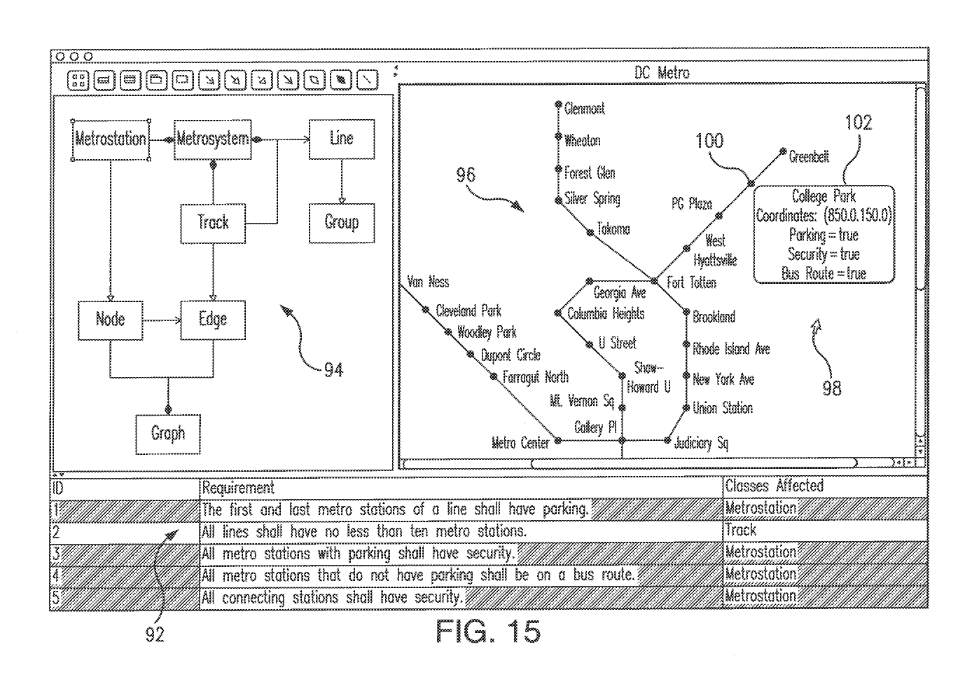

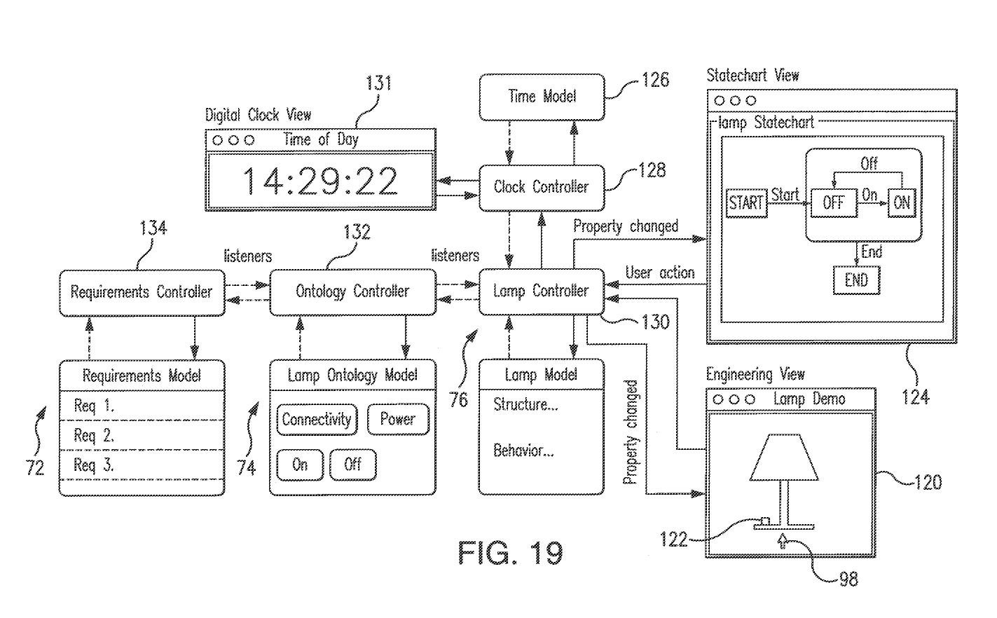

When an engineer/designer interacts with an item in one view, though, for example, a cursor 98, shown in FIGS. 15 and 19, the synchronization procedures 28 shown schematically in FIGS. 2 and 8 will highlight: (1) other views of the same entity within the same workspace, and/or (2) items in other workspaces that are connected through requirements-ontology-engineering traceability linkages 32. The interaction mechanism 38 functions within the traceability network 32 to enhance correlative visualization between contents of the workspaces in question.

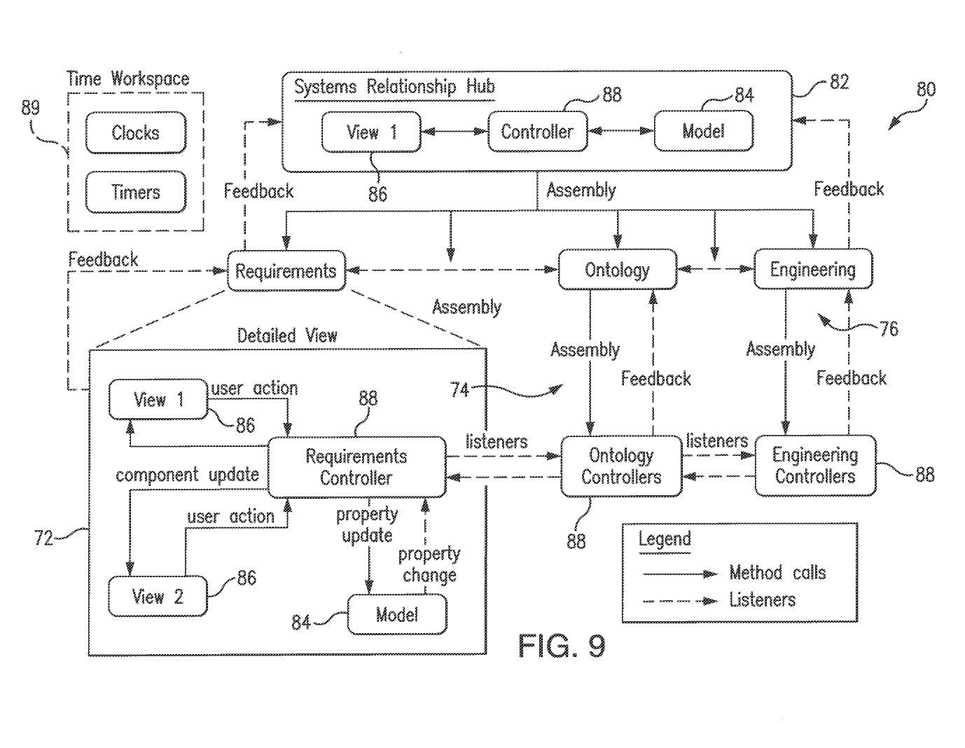

FIG. 9 shows the subject system architecture 80 being implemented as a pyramid (i.e., a two-level graph) of model-view-controllers. The systems relationship hub (SRH) 82 is responsible for defining high-level system development entities and their initial connections, and then systematically assembling the graph infrastructure to mimic the graph structure and workspaces 72, 74, 76 shown in FIG. 8. Each block 72, 74, 76 employs a combination of the mediator and model-view-controller design patterns. The requirements block 72 is expanded in FIG. 9 to show the details of model 84, view 86 and controller 88 interaction.

It is contemplated that an event-based model may be used for synchronization of states and data in views and models in the subject system. The expanded requirements block 72 in FIG. 9 illustrates this provision. Specifically, user actions detected in views 86, e.g., when a user highlights a row in a table of requirements (shown, for example, in FIGS. 6, 15, and 19-20), are propagated to the controller 88, which, in turn, forwards the updates to related views within the same workspace and to the controllers of connected workspaces. Similarly, property changes to a model 84 are sent to the controller 88 for distribution to related viewpoints and to the controllers of connected workspaces.

The fully developed system 80 has workspaces 72, 74, 76 corresponding to the requirements, ontology and engineering phases of system development (FIG. 8), plus a time workspace 89 responsible for delivering temporal information to the system model via clocks and timers.

It is important to note that in moving from FIG. 8 to FIG. 9, the mechanism of communication among entities is more specific. The requirements, ontology and engineering workspaces 72, 74, 76, are shown as being implemented as networks of model-view-controllers (MVCs). Models do not communicate with other models. Views do not communicate with other views. Instead, models and views can only communicate through their controllers. Thus, workspaces communicate via interaction mechanisms between controllers. Therefore, the fully implemented system is designed as a network of MVCs.

In the subject system, a designer is provided with tools to freely interact with the symbols in each viewpoint and for changes in status to be synchronized across viewpoints. Such a framework is capable of transforming the requirements-ontology-engineering workspaces into spreadsheet-like support for engineering design and systems management.

In order for ontology-enabled traceability mechanisms to be useful for systems engineering practitioners they need to fit into and support the execution of well-defined systems engineering processes. Examples may include the Waterfall Model of Development, the Spiral Model of Development, and the V-Model of System Development.

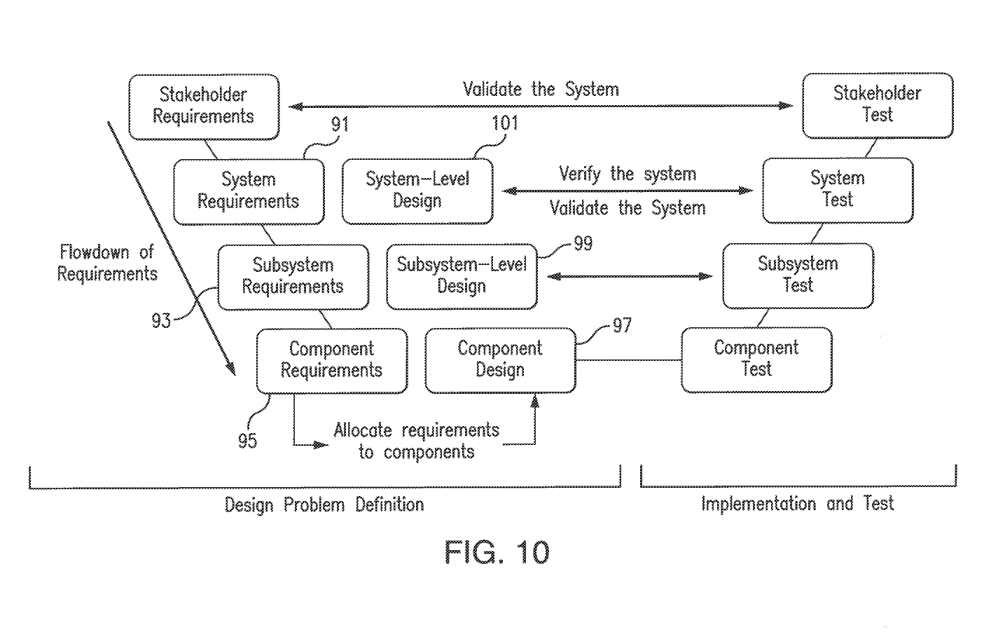

The systems engineering projects usually are developed in layers, beginning with the development of requirements for the “big picture view” held by the project stakeholders, and finishing with component-level requirements. FIG. 10 shows, for example, the flowdown of requirements and tentative designs in the V-Model of System Development. Source requirements are derived from stakeholder needs. Each stage of the decomposition process places additional constraints on the space of acceptable design solutions. For example, engineering analyses/simulations often lead to additional (derived) requirements.

As shown in FIG. 10, the decomposition and refinement of design (object) details begins at the system level (shown as block 91) and flows down to the subsystem (shown as block 93) and component levels (shown as block 95). Once the details for a system (object) have been fully specified at each layer of abstraction, implementation begins, but in the reverse order (component 97, subsystem 99, system 101).

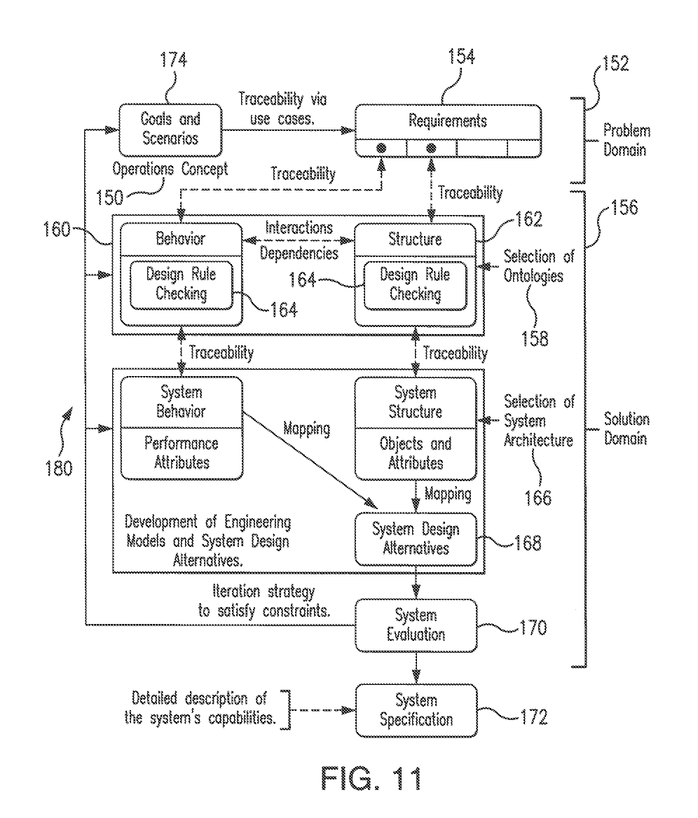

Referring to FIG. 11, a step-by-step procedure is presented which corresponds to the subject ontology-enabled traceability mechanisms embedded in each of the levels (i.e., stakeholder requirements, as well as system requirements, subsystem requirements, and component requirements 91, 93, 95) shown in of FIG. 10. Within each layer of development, the step-by-step procedure for requirements (blocks 91, 93, 95) and design (blocks 97, 99, 101) is carried out through the following steps:

1. Starting with the stakeholder needs, and possibly requirements/constraints passed down from higher layers, an operations concept 150 is formulated in a Problem Domain 152 of the system development process. The operations concept focuses on system functionality (which is concerned with what the system does, who will use the system). The operations concept leads to requirements on system functionality, performance and cost.

2. Further, the requirements 154 are organized. Some requirements may be associated with the object (system) behavior. Other requirements may be associated with the system structure and interfaces between systems.

3. In the next phase of the system development process, i.e., in the Solution Domain 156, for each requirement 154, a designer selects in step 158 one or more ontologies containing concepts which he/she believes may lead to a sound object (system) solution.

4. Further in the process, engineering models for system behavior 160 and system structure 162 are created. Procedures for Design rule Checking 164 are attached to the ontologies. At this stage of the development process, the Design Rule checking procedure 164 (also illustrated in FIG. 6 and described in corresponding paragraphs) may be applied. The Interactions/Dependencies mechanisms (shown in FIGS. 4-5 and described in corresponding text) are applied in this phase of the system development process.

5. In the following phase, i.e. Selection of System Architecture 166, system design alternatives are created by mapping models of system behavior onto the system structure. This mapping process may be thought of as an assignment of fragments of system functionality to subsystems/components (e.g., component A is responsible for implementing function B).

6. When system design alternatives 168 are created, each system design alternative is evaluated in step “System Evaluation” 170 against the metrics of acceptable cost, correct functionality, and adequate performance.

There are two outcomes to Step 6. When all of the constraints are satisfied and all of the measures of system effectiveness are met, one can proceed to Step 7. Otherwise, iterations of development will be needed either to satisfy constraints of improve upon the measures of effectiveness.

7. In the following step, a system specification 172 (i.e., a detailed description of the design's capabilities) is generated. Otherwise the system evaluation 170 is iterated (by looping to “Goals and Scenarios” block 174) to either satisfy constraints or improve economics.

The feedback arrows 180 shown in FIG. 11 indicate the ways of adjustments to the requirements, selection of ontologies, or details of the system behavior and/or system structure models which may be performed to provide that the engineering object (systems, solution) may be improved when needed.

A three-level framework for the implementation of ontology-enabled traceability mechanisms of the present invention, i.e., at the object level, the workspace level, and the system level, has been designed. At all levels of this hierarchy, and at all stages in the system development process, engineering objects are implemented using the model-view-controller design pattern presented in FIG. 9 supra, which shows that all entities contained in a workspace are based on model-view-controller scheme. System-level structure is a graph of connected workspaces. System-level behavior emanates from the synchronization of data between workspaces, i.e., the requirements, ontology, and engineering model workspaces 72, 74, 76 shown in FIGS. 8-9.

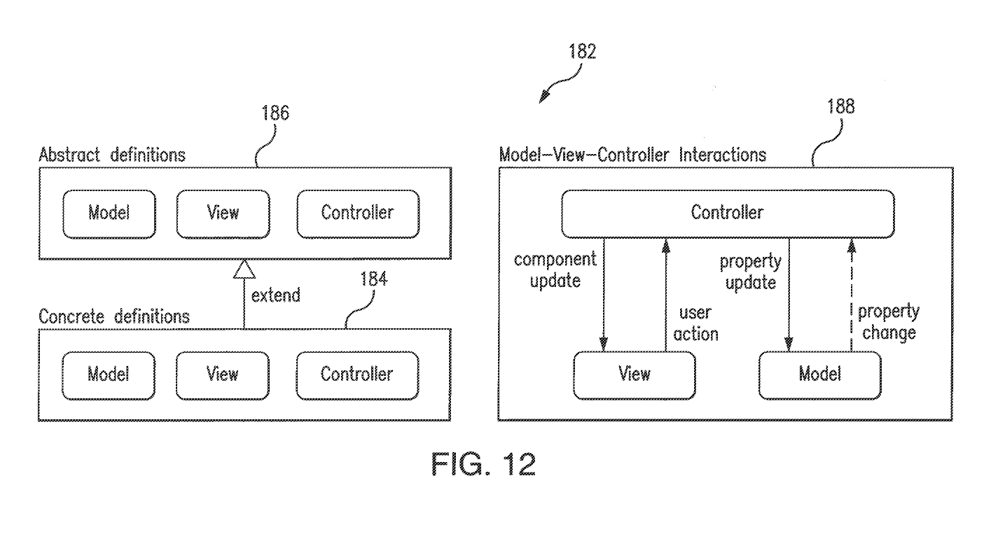

Referring to FIG. 12 which represents the essential details of a conventional behavior modeling with the model-view-controller design pattern 182, it is assumed that the behavior of objects and components is modeled as extensions of concrete definitions 184 to abstract class definitions 186 for a general-purpose controller, model and view. This abstract framework does not constitute an inventive portion of the present system. Together, the abstract classes provide the basic infrastructure to assemble the graph of interactions 188. By registering with a controller, a view may send user actions to the controller and receive component updates. Similarly, by registering with a controller, a model may receive property updates from the controller and sent property change events to the controller. In accordance with the arrangement presented in FIG. 12, the object-level behavior is defined by sequences of events in either the views or models, and their subsequent processing. In the concrete implementations of model, view and controller, discipline-specific detail is added.

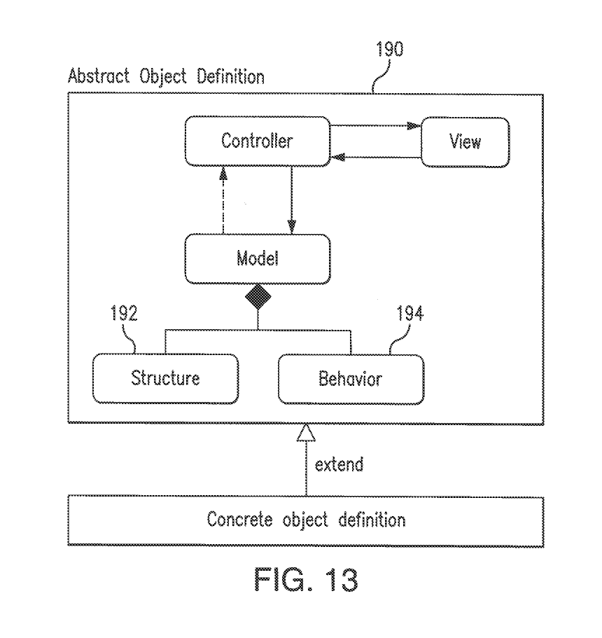

The conventional implementations shown in FIG. 12 have been extended for the modeling of object-level behavior in the subject system ontology-enabled traceability. First, it is contemplated in the present system that all entities across the requirements, ontology, and engineering model workspaces are treated in a consistent manner. This problem is solved with an abstract object class 190 shown in FIG. 13 that mandates construction of a single model-view-controller, and provides functionality for the entity controller to be registered with the workspace controller as will be detailed in further paragraphs.

Another extension is due to the nature of systems engineering development processes. As illustrated in FIG. 13, models for object structure 192 and object behavior 194 have been separated. The object structure 192 contains attributes of the object (e.g., color, size, position) Object behavior 194 is defined in sets of states, transitions, and guard conditions, sequences of tasks, etc.

These extensions are handled with the class hierarchy shown in FIG. 13. The formulation is unique in the sense that all objects are provided with the right to implement behavior, even in cases where inclusion of the object behavior would not normally occur. For example, in the Metro System application (presented in further paragraphs), metro stations are part of the system structure i.e., they have no apparent behavior. Yet, in this formulation, support is provided for the metro station object to actively respond to user-interactions. Concrete object definitions may be created for all workspace objects.

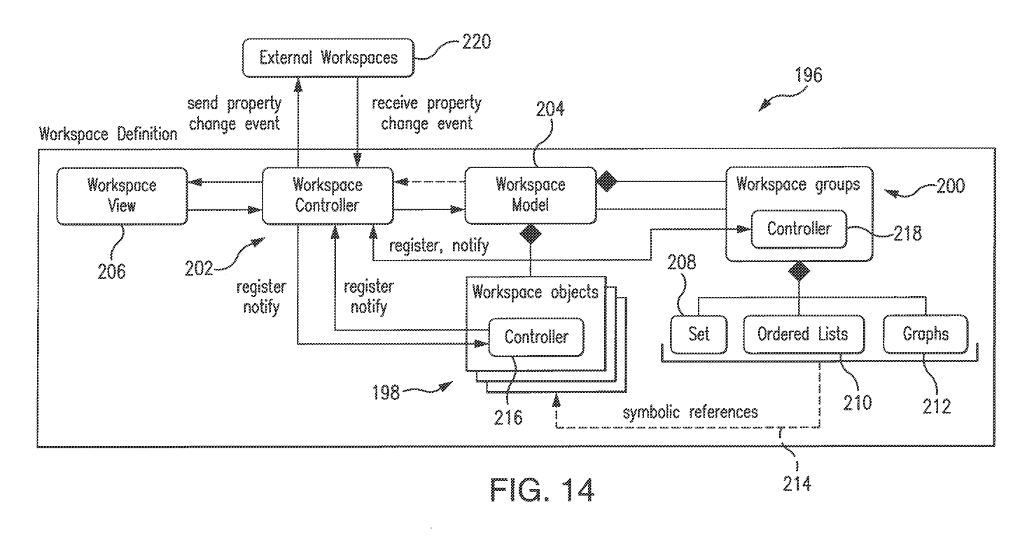

Referring to FIG. 14, where the essential elements and structure of a generic workspace are presented, a workspace 196 contains workspace entities 198 and groups 200 of workspace entities. The workspace 196 includes a workspace controller 202, a workspace model 204, and a workspace view 206.

The workspace model serves two purposes: it acts as a library for the storage of workspace objects (entities); another purpose of the workspace model is to support workspace groups 200, that is, collections of workspace objects (entities) organized into set 208, ordered list 210, and graph data structures 212. Workspace groups do not store objects. Instead they refer to objects in the workspace library via symbolic references 214.

The workspace controller 202, individual workspace object controller 216, and workspace group controller 218 are organized into a hub-and-spoke network structure. Each workspace object controller 216 and workspace group controller 218 registers with the workspace controller 202. The workspace controller 202 registers with: (1) the external workspaces 220, (2) the workspace views 206, (3) the workspace model 204, (4) the individual workspace object controllers 216, and (5) the workspace group controllers 218.

In the subject system, the system-level behavior is defined by the exchange of property change evens (part of JavaBeans) among workspace controllers, as illustrated in FIGS. 14, and 19-20.

In the subject system, the workspace-level behavior is implemented through (1) handling of events generated at the object level, and (2) incoming events that have been generated in external workspaces 220. The processing of events is carried out through handling of events locally, and updated object models and views within the workspace, as well as via propagating the events to the workspace controller for distribution to external workspaces. To avoid unnecessary processing and loops, object within a workspace are provided with unique identifications (ids). In addition, each workspace also is provided with a unique identification.

To demonstrate the breadth and usefulness of the subject approach, five applications are described in the following paragraphs. The applications 1 and 2 highlight traceability of requirements to system structures, that is, to the attributes of physical components and subsystems within the system itself. Applications 3 and 4 highlight the traceability of requirements to elements of system behavior. The application 5 links behavior modeling to performance assessment.

### Application 1. System Architecture of the Washington D.C. Metro System

Referring to FIG. 10, which represents a graphical display of requirements class 92, ontology class 94, and a plan view 96 of the Washington D.C. Metro System. The requirements field 92 contains only five requirements, which are displayed in a table format. UML class diagrams are used to display ontology concepts 94. Other formats of visual representations for ontologies are possible as well. In this prototype, the scope of the software implementation is focused on the design of the metro system architecture (i.e., station, tracks and lines), with no trains considered.

This specific screen capture occurs when a user's mouse 98 is positioned over the College Park Metro Station 100. A popup bubble 102 displays attributes of the College Park Metro Station (parking, security, bus route, etc.).

FIG. 15 represents an implementation of the system architecture shown in FIG. 7. The requirements, ontology, and engineering models synchronize their states through the use of traceability mechanisms implemented as graphs of listener mechanisms. Thus, when a user interacts with an object in the engineering view 96, messages for event interaction are propagated to the ontology 94 and requirements views 92. The College Park Metro Station conceptually is both a Metro Station in a Transportation network, and a Node in a Graph.

### Application 2. Renovation of a Wall in a House/Provision for Design Rule Checking

In this prototype, a house was renovated by installing a window into a load-bearing wall. A framework was established for design rule checking 50 which is one of essential elements of ontology-enabled traceability shown in FIG. 6.

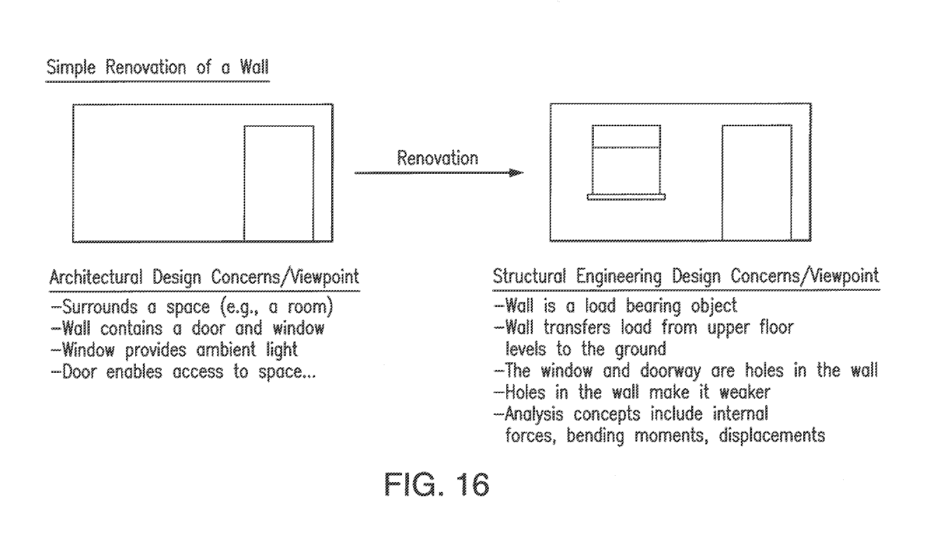

Assuming that a load-bearing wall in a house contains a door, but the neighboring space is too dark, an architect decides that the problem can be solved by installing a window. This process is illustrated in FIG. 16.

From an architectural perspective, the wall helps to define a space, which, in turn, will support a prescribed function for the occupants of that space (e.g., a room). A doorway provides access to the occupants and a window provides ambient light. Since the wall is a load bearing structure, part of its purpose will be to provide a pathway for safe transmission of gravity forces to the foundation.

Structural engineers, on another hand, are responsible for making sure that the wall will have sufficient strength for this to occur, and to keep displacement and stability concerns within permissible limits. For this application, the architectural and structural engineering viewpoints are not only interconnected through the size and positioning of the new window, but also are in conflict. This anomaly arises due to the fact that a large window may provide superior levels of ambient light, but correspondingly decreases the wall strength.

Provision for Design Rule Checking at the Model Level.

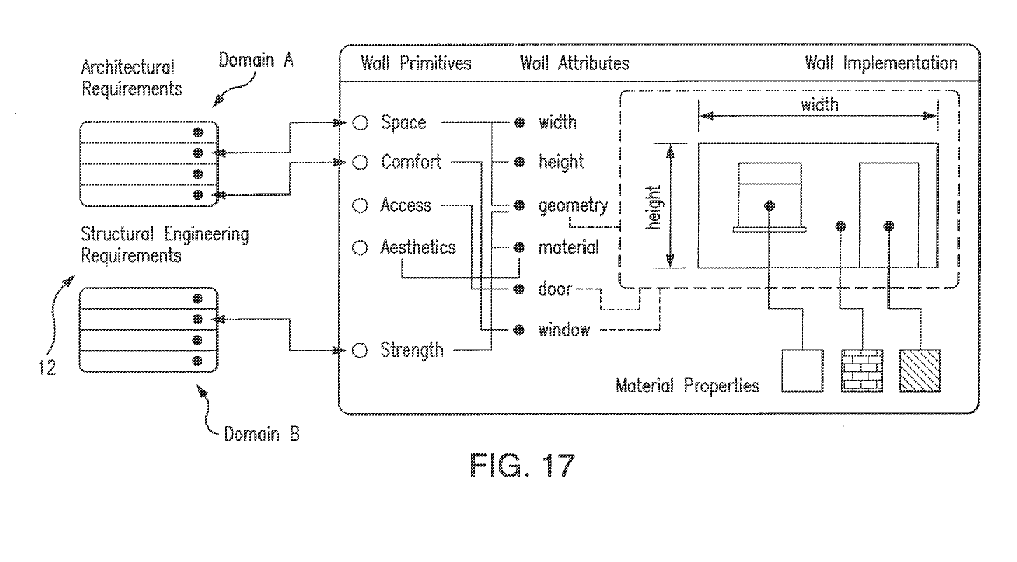

Referring to FIG. 17, which is a schematic for the capture of dependencies between architectural and structural engineering design concerns in requirement module 12 at the model level, it is shown that each discipline (in the respective Domain A and Domain B) will design their system to serve one or more purposes. For example, architects are concerned with provision of spaces, comfort, access and aesthetics. Structural engineers are concerned with the transfer of forces from a structure to its foundation.

As indicated in FIG. 17, the wall's measures of effectiveness can be represented by Wall Primitives which, in turn, can be traced to wall attributes and aggregated groups of wall attributes. For example, one of the wall's primary architectural purposes is to participate in the definition of a space (e.g., a room). The characteristics of the space (e.g., its shape and size) will depend on the wall geometry. The term “geometry” is used herein as a reference to a collection of lower-level geometric and topological quantities.

It is also assumed that comfort of an occupant will be affected by the presence (or lack thereof) of a window. Then, in turn, the window dimensions and positioning will affect the wall geometry. Access and Aesthetics primitives are tied to the existence of a door and choice of material. In addition, it is assumed that structural engineers are mainly interested in the wall strength, which, in turn, depends on the wall geometry and choice of material.

### Provision for Design Rule Checking at the Ontology (Meta-Model) Level.

In contrast to the approach taken in FIG. 17, ontology-enabled traceability of the subject system assumes that the most important design concepts and dependencies among concepts can be represented at the meta-model (or ontology) level.

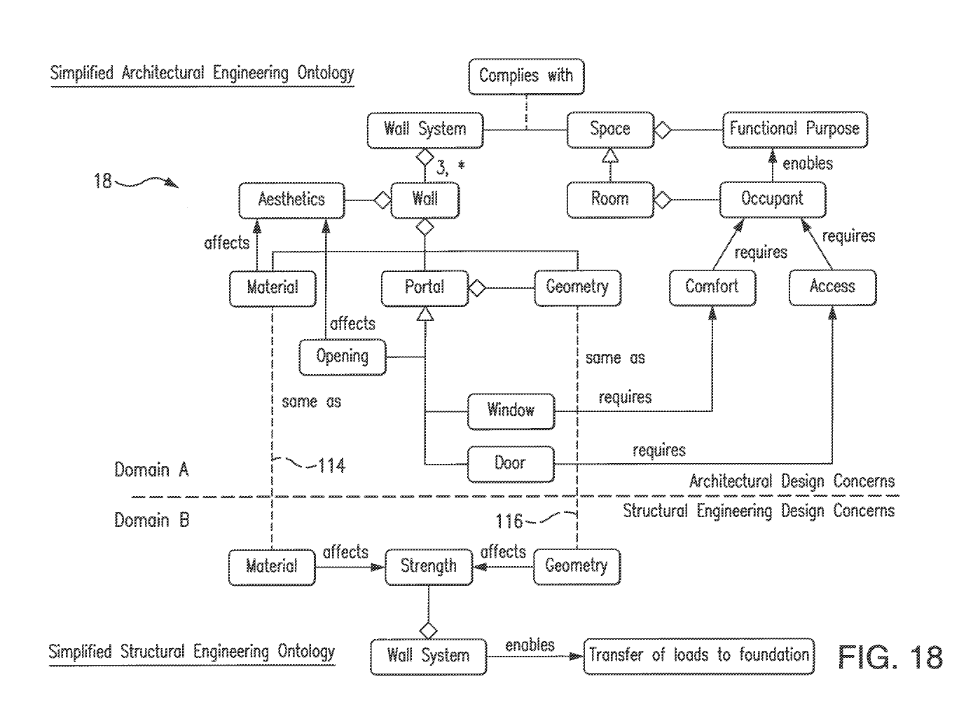

FIG. 18 shows simplified ontologies 18 for the architectural (Domain A) and structural engineering (Domain B), together with the linkage of domains specific concerns through interaction mechanisms. Within the architectural Domain A, for example, the ontology provides an explicit description for how a wall fits into the wall system which, in turn, complements definitions for a space and room. Individual walls are a composition of material properties and wall geometry, and they may contain portals (portal is a generalized term for opening, window or doorway).

The functional purpose of doors and windows can be connected to occupant needs (e.g., access and comfort) through the use of dependency relationships. From a structural engineering perspective, i.e. in the structural engineering Domain B, the wall system must have sufficient strength which, in turn, depends on the selection of material properties and the wall geometry. In this simplified scenario, the architectural and structural engineering Domains A, B are linked through notions of material 114 and geometry 116. In this case both viewpoints are the same item.

There are several advantages in linking design concepts at the ontology/meta-model level. First, provision for design rule checking at the ontology level is project neutral. Design concepts and relationships among design concepts can be reused across an entire family of project instances. A second key benefit is that it is much easier to show how a design concept entity relates to other entities. In other words, working at the ontology level facilitates a “big picture” view of the essential concepts and relationships among concepts in a design situation. The subject system is capable of unique linking of ontologies/meta-models for the purposes of enabling ontology-enabled traceability across multiple domains.

### Application 3. Behavior Modeling for a Simple Lamp/Provision for Requirements to Behavior Traceability.

In this application, illustrated by FIG. 19, the objective is to develop a software infrastructure that will permit the modeling of system behaviors as networks of communicating finite state machines in a manner consistent with FIGS. 2-3, and 9.

To provide scalability and the possibility of concurrent processes operating within a single system, finite state machine behavior models are built from an abstract model-view-controller assembly and extensions for statechart behaviors. Appropriate interfaces and abstract class definitions are added for the assembly of traceability models.

Metadata is used to recognize the runtime-specific data used by the statechart (i.e., to keep a list of states, currently active states, transitions and guard conditions). The Metadata class fires property change events when the statechart enters a new state or starts a transaction. Changes in state can also occur when events are fired in the statechart model. Support for traceability includes state and transition classes, both of which initiate property change events when their activity status is updated. Guard conditions are interfaces that verify the availability of a transition through the evaluation of evaluate Boolean expressions in the statechart. Guard interfaces notify the controller when their status is evaluated to either true or false.

Considering behavior of a simple lamp having an on/off switch and a clock, Table 1 summarizes the system requirements and expected behavior.

TABLE 1
Lamp requirements and expected behavior.

| System Requirements | Expected Behavior |
|---|---|
| 1. The lamp shall be switched | When the time is 8 p.m., the statechart |
| to “on” when time is 8:00 p.m. | will transition to the “On state” if it is |
| | not already in that state. |
| 2. The lamp shall be switched to | When the time is 7 a.m., the statechart |
| “off” when time is 7:00 a.m. | will transition to the “Off state” if it is |
| | not already in that state. |
| 3. The user shall be able to | When the user clicks the switch button |
| switch the lamp “off” at any | (small black box) in the lamp view, the |
| given time. | lamp will turn “off” if it is “on”. |
| 4. The user shall be able to | When the user clicks the switch button |
| switch the lamp “on” at any | (small black box) in the lamp view, the |
| given time | lamp will turn “on” if it is “off”. |

Within each workspace 72, 74, and 76, the model, view and controller classes are extensions of their abstract counterparts (e.g., AbstractModel). As shown in FIG. 19, the engineering model 76 has a system structure (i.e., defined by attributes for lamp geometry, color, style) plus a model for system behavior implemented as a small network of controller behaviors. Basic behavior is handled by a lamp controller 130. A clock unit 131 provides a switch for the map to be turned on/off, subject to the lamp being connected to a power supply (i.e., any transition to an On state will only occur when a guard check on power evaluates to true).

A clock and time model 126 are added in order that requirements 1 and 2 in Table 1 may be satisfied.

The observer design pattern regulates communication among the controllers 128, 130, 132, and 134, both locally within a workspace, and globally throughout the traceability network. A user can interact with the engineering view 120 by clicking the switch 122 on and off through the use of the cursor 98. Changes in the lamp state are automatically propagated to the statechart view 124, and also to a requirements table view and ontology graph view.

### Application 4. Behavior Modeling for Trains in the Washington D.C. Metro System

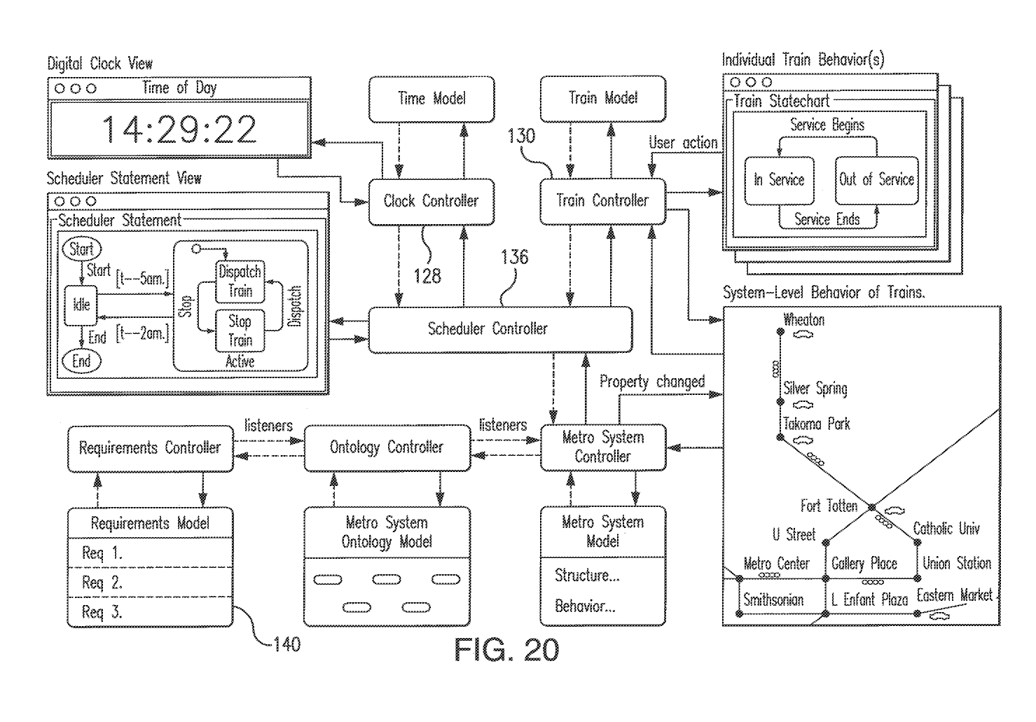

FIG. 20 is a schematic of the partially complete requirements-ontology-engineering system architecture as applied to behavior modeling of trains and schedulers in the Washington D.C. Metro System.

The system architecture is implemented as a network of communicating model-view-controllers (MVCs). The general pathway of communication among entities is as follows: the time controller 128 notifies the scheduler controller 136, a controller having behavior, about a change in time.

The scheduler controller 136 triggers the train controller 130 to send/stop a train. A change to the train model (e.g., because the train has moved) will result in a call to the train controller, which in turn will trigger an update to the statechart view. Finally the change in the statechart behavior model will impact the requirement model 140. The requirement table view will highlight the requirement or requirements affected by the fragment of system behavior.

FIG. 20 shows a chain of loosely coupled workspaces for requirements, ontology, engineering development, and time workspace. Within each workspace, the model, view and controller classes are extensions of their abstract counterparts. Individual workspaces register with and are connected to other workspaces via their controllers (observer software pattern). When a local change happens in the system, the controller, which received the change notifies the listeners of a change providing the list of controllers who have received this change and its own local Id as a source. This approach avoids the potential possibility of listeners sending multiple copies of a communication and forming loops.

When a recipient controller receives a change, it updates its own model. After the model being updated, the controller is called again since it is a listener to its own model. The controller notifies the view as well as other listener controllers about the recent change in the model to be updated.

### Application 5. Linking Behavior Modeling to Performance Assessment and Trade Study Analysis.

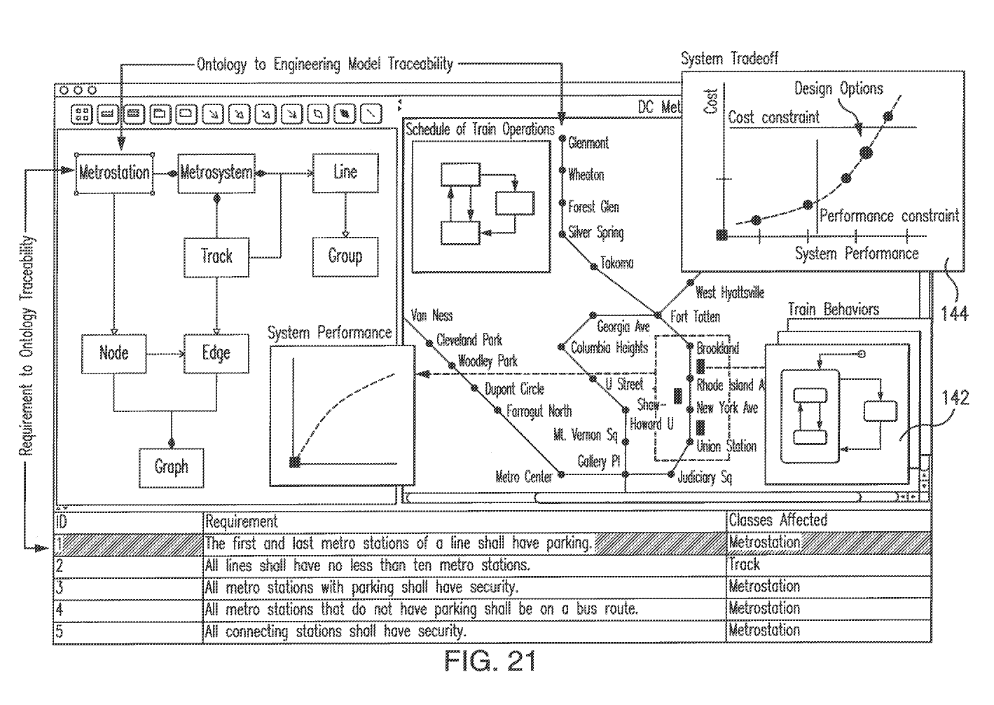

Applications 3 and 4 presented in previous paragraphs may be considered steps for extending ontology-enabled traceability model along the lines of the annotations shown in FIG. 21.

The addition of timetable-driven train behavior 142 to the Washington D.C. Metro System model opens the possibility of traceability connections between functional/performance requirements and individual states, and even the value of attributes within states of behavior models. This capability will provide a direct pathway from requirements to evaluation of performance attributes, which, in turn, will allow for tradeoff studies 144.

Although this invention has been described in connection with specific forms and embodiments thereof, it will be appreciated that various modifications other than those discussed above may be resorted to without departing from the spirit or scope of the invention as defined in the appended claims. For example, functionally equivalent elements may be substituted for those specifically shown and described, certain features may be used independently of other features, and in certain cases, particular locations of elements, steps, or processes may be reversed or interposed, all without departing from the spirit or scope of the invention as defined in the appended claims.

What is being claimed is:

1. A system for ontology-enhanced traceability in engineering objects development, comprising:
a computer system having a processor configured for developing an engineering object solution based on requirements received at an input of said computer system,
said computer system including:
at least one processor executable requirement module containing said requirements,
at least one processor executable engineering object module adapted to calculate said engineering object solution to meet said requirements,
at least one processor executable traceability link operatively coupled between said at least one engineering object module and said at least one requirement module, and
at least one processor executable design concept module embedded in said at least one traceability link, wherein said at least one design concept model module contains a set of concepts justifying a tentative solution for said engineering object in view of said set of requirements.

2. The system of claim 1, wherein said at least one design concept model module contains semantically based information pertaining to at least one domain describing said engineering object, wherein said information is being stored in ontologies.

3. The system of claim 1, further comprising a processor executable visualization unit controlled by said computer system and operatively coupled to said at least one traceability link, said at least one requirement module, said at least one design concept module, and said at least one engineering object module to display, in a predetermined format, contents of said modules, and structural and behavioral correlation between said set of requirements, said set of concepts, and said engineering object solution.

4. The system of claim 1, further comprising a processor executable design rule checking module operatively coupled to said at least one design concept module.

5. The system of claim 4, further including a system of sensors operatively coupled to said at least one engineering object module, said system of sensors generating data representative of said engineering object status, said data being supplied to said design rule checking module,
wherein said at least one design concept module outputs a signal transmitted to said at least one requirement module when a status of said engineering object module changes.

6. The system of claim 5, further including a visual indicator operatively coupled to said at least one requirement module to display changes in the status of said set of requirements.

7. The system of claim 1, wherein said at least one engineering object module produces said engineering object in form of a design model, a physical entity, or an element of the engineering object behavior.

8. The system of claim 3, wherein said predetermined format includes engineering drawings, requirements diagrams, block-diagrams, activity diagrams, sequence diagrams, and statechart diagrams.

9. The system of claim 1, further comprising a first plurality of requirement model modules, interconnected to form a processor executable requirements model workspace, a second plurality of design concept model modules interconnected to form a processor executable design concept model workspace, and a third plurality of engineering object model modules interconnected to form a processor executable engineering object model workspace, and
a processor executable ontology-enhanced traceability network linking said requirement model workspace, said design concept model workspace, and said engineering object model workspace, wherein said traceability network contains at least one bi-directional respective processor executable interaction mechanism coupled between respective modules in said workspaces.

10. The system of claim 9, wherein said at least one respective interaction mechanism is composed of a dependency unit and a links unit, said dependency unit including an association relationship unit and organizational relationship unit, and wherein said links unit includes a compliance relationship unit and satisfaction relationship unit.

11. The system of claim 9, wherein said traceability network is partitioned at a plurality of cross-cutting viewpoints levels, each corresponding to a specific stage of said engineering object development lifecycle.

12. The system of claim 9, wherein said traceability network is partitioned in a plurality of basic viewpoints, each corresponding to a predetermined aspect of said engineering object development.

13. The system of claim 9, wherein said requirement model workspace covers a plurality of requirements domains interrelated through said ontology-enhanced traceability network.

14. The system of claim 9, wherein each of said requirement model, design concept model, and engineering object model workspaces includes a respective workspace controller, and wherein said workspaces communicate through said controllers.

15. The system of claim 14, wherein said controllers are coupled therebetween in a network of at least one source controller and a plurality of receiving controllers, wherein said at least one source controller notifies said plurality of receiving controllers of a status change in a respective workspace along with a list of workspace controllers being notified.

16. The system of claim 3, wherein at least one of said at least one requirement module, said at least one engineering object module, and said at least one design concept module is implemented with uniform modeling language (UML), systems engineering markup language (SysML), or Web Ontology Language (OWL).

17. The system of claim 1, wherein each of said at least one requirement module, at least one design concept module, and at least one engineering object module is adapted to manage connectivity relationships with other said modules, and to propagate changes in the status of said modules when detected.

18. A method for ontology-enabled traceability in a process for engineering object development, comprising he steps of:
(a). providing a computer system having a processor;
(b) configuring said computer system to create a system architecture composed of a first plurality of processor executable requirement model modules and a second plurality of processor executable engineering object model modules,
(c) interconnecting said first plurality of requirement model modules and said second plurality of engineering object model modules via a processor executable traceability network,
(d) embedding into said traceability network a third plurality of processor executable design concept model modules, wherein each design concept model module is coupled between a respective requirement model module and a respective engineering object model module;
(e) through a computational process in said computer system, partitioning said system architecture in a requirement model workspace composed of said first plurality of requirement model modules interconnected therebetween through said traceability network, a design concept model workspace composed of said third plurality of design concept model modules interconnected therebetween through said traceability network, and an engineering object model workspace composed of said second plurality of engineering object model modules interconnected therebetween through said traceability network;
(f) visualizing, in a respective predetermined format, contents of each of said requirement model workspace, design concept model workspace, and engineering object model workspace on a display unit;
(g) interacting with at least one first item contained in at least one of said requirement model workspace, design concept model workspace, and engineering object model workspaces through said display unit, thereby initiating through said computer system a synchronization procedure adapted to correlate, through said traceability network, said at least one first item to at least one second item in said at least one workspace or in workspaces other than said at least one workspace, wherein said at least one second item being related to said at least one first item through said ontology-enhanced traceability network, and
(h) displaying said at least one second item on said display unit in correlation with said at least one first item.

19. The method of claim 18, further comprising the step of:
partitioning said traceability network into a plurality of cross-cutting view-points levels, each corresponding to a specific stage of said engineering object development lifecycle.

20. The method of claim 18, further comprising the step of:
in said step (b), linking, through said traceability network, design concepts pertaining to a plurality of domains.
